(19) United States
(12) Patent Application Publication
(10) Pub. No.: US 2025/0301438 A1
(43) Pub. Date: Sep. 25, 2025

(54) METHODS AND NETWORK INFRASTRUCTURE EQUIPMENT

(71) Applicant: Sony Group Corporation, Tokyo (JP)

(72) Inventors: Martin Warwick BEALE, Basingstoke (GB); Samuel Asangbeng ATUNGSIRI, Basingstoke (GB)

(73) Assignee: Sony Group Corporation, Tokyo (JP)

(21) Appl. No.: 18/863,668

(22) PCT Filed: Apr. 20, 2023
(86) PCT No.: PCT/EP2023/060249

§ 371 Date: Nov. 7, 2024

(30) Foreign Application Priority Data
May 23, 2022 (EP) 22174951.8

(51) Int. Cl. H04W 64/00; H04W 84/06

(52) U.S. Cl. CPC H04W 64/00; H04W 84/06

(57) ABSTRACT

A communications device method involves receiving signals from a non-terrestrial network (NTN) at different orbital locations. First, a signal is received from the NTN infrastructure in an initial orbital position, enabling the device to make a primary measurement. Later, additional signals are received as the NTN moves to other orbital locations, allowing for further measurements. The device then sends an indication of the measurement differences to the network, enabling location determination or verification of the device via multilateration. Observed time differences between downlink or uplink signals aid in verifying the device's position by comparing known transmission times with NTN location data.

### BACKGROUND

### Field of Disclosure

The present disclosure relates to methods of determining or verifying a location of a communications device or user equipment based on signals transmitted or received by a non-terrestrial network (NTN) infrastructure equipment and an NTN infrastructure equipment and communications devices or user equipment. The present disclosure claims the Paris Convention priority of European patent application number EP22174951.8, the contents of which are incorporated herein by reference in their entirety.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Wireless communications networks are now supporting communications to a wider range of communications devices and user equipment for a variety of applications and data traffic profiles and types. For example, communications are now supported with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance.

In order to provide coverage for an increasing range of devices, such as IoT, 5G radio access technologies (RAT), also referred to as new radio (NR) systems, includes aspects which are devised to support connectivity over a wide range of environments. For example, in order to improve coverage for communications devices (user equipment etc.) wireless communication networks may include infrastructure equipment mounted on or forming part of satellites which are able to provide coverage for wireless communications by transmitting and receiving radio signals to and from communications devices located on the earth. Such satellites may be geostationary or in low earth orbit or medium earth orbit as will be explained in more detail below. Communications networks which include infrastructure equipment mounted on or forming part of satellites are known as Non-Terrestrial Networks (NTNs) and include both 5G networks as well as future iterations and releases of existing systems. Such NTNs can be configured to provide a complete range of services which would otherwise be provided by terrestrial wireless communications networks. However, some services such as location-based services can present new challenges.

### SUMMARY OF THE DISCLOSURE

The present disclosure can help address or mitigate at least some of the issues discussed above.

Example embodiments can provide a method by a communications device (user equipment, UE) comprising receiving, from a non-terrestrial network (NTN) infrastructure equipment forming part of a wireless communications network, a first signal, the first signal having been transmitted when the NTN infrastructure equipment is in a first orbital location, determining a first measurement based on the received first signal, receiving, from the NTN infrastructure equipment at a time later than a time of the reception of the first signal, at least one further signal, the at least one further signal being received when the NTN infrastructure equipment is in one or more different orbital locations, which are different from the first orbital location and determining at least one further measurement based on the received at least one further signal. The method further comprises transmitting an indication for determining a relative difference between the determined first measurement and the determined at least one further measurement to the wireless communications network over a wireless access interface provided by the wireless communications network for the wireless communications network to determine or to verify a location of the communications device based on the indication of the determined first and at least one further measurements, caused by the NTN infrastructure equipment being in the first and the one or more different orbital locations when the first signal and the at least one further signal were transmitted. The determined first and at least one further measurements may be used to determine an observed time difference of arrival based on an inter-arrival time of downlink signals transmitted by the NTN infrastructure equipment at known times, so that the network or the NTN infrastructure equipment can determine or verify the location of the communications device by multilateration by identifying a location of the NTN infrastructure equipment from ephemeris information at a time when the downlink signals were transmitted.

Example embodiments can also provide a method performed by a communications device (user equipment, UE) comprising transmitting, to a non-terrestrial network (NTN) infrastructure equipment forming part of a wireless communications network, a first reference signal via a wireless access interface of the wireless communications network formed by the NTN infrastructure equipment, the first reference signal being transmitted at a time determined from a reference forming part of the wireless access interface and the first reference signal is transmitted when the NTN infrastructure equipment is in a first orbital location, transmitting, to the NTN infrastructure equipment at a time later than a time of the transmission of the first reference signal, at least one further reference signal via the wireless access interface the at least one further signal being transmitted when the NTN infrastructure equipment is in one or more different orbital locations, which are different from the first orbital location, the at least one further reference signal being transmitted at a time determined from a reference forming part of the wireless access interface. A difference in an arrival time of the first reference signal and the at least one further reference signal with respect to the reference of the wireless access interface can be used to determine by the wireless communications network a location of the communications device or to verify a location of the communications device based on measurements determined by the NTN infrastructure equipment, the difference in an arrival time being caused by the NTN infrastructure equipment being in the first and the one or more different orbital locations when the first reference signal and the at least one further reference signal were transmitted.

Example embodiments can provide a method for a communications device to make measurements from downlink signals received from an NTN infrastructure equipment or for an NTN infrastructure to make measurements from uplink signals received from a communications device, from which differences between the received signals can be used to determine or to verify a location of the communications device.

Respective aspects and features of the present disclosure are defined in the appended claims and include an NTN infrastructure equipment and an apparatus forming part of a wireless communications network for determining or verifying a location of a communications device/UE and methods of the same.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of a 5G/new radio access technology (RAT) wireless communications system which may be configured to operate in accordance with embodiments of the present disclosure;

FIG. 2 is a schematic block diagram of an example infrastructure equipment and a communications device which may be configured to operate in accordance with embodiments of the present disclosure;

FIG. 3 is an illustrative representation of a plurality of parts of infrastructure equipment forming a wireless communications network in which some parts of the infrastructure equipment are located in satellites above the Earth and other parts may be located on the ground of the Earth, which form part of an NTN wireless communications network;

FIG. 4 is an illustrative representation of a plurality of parts of an NTN wireless communications network that serves a user equipment, where some parts of the infrastructure equipment are located in satellites above the earth and operate in a transparent manner;

FIG. 5 is an illustrative representation of a plurality of parts of an NTN wireless communication network that serves a user equipment, where some parts of the infrastructure equipment are located in satellites above the earth and perform some base station functionality;

FIG. 6 is an illustrative representation of NTN infrastructure equipment in orbit above the Earth, which form a wireless communication network that serves a user equipment;

FIG. 7 is an illustrative representation of triangulation performed on a user equipment in communication with three infrastructure equipment (eNB) illustrating a location based determination method using a downlink time difference of arrival technique;

FIG. 8 is an illustrative representation of a number of resource elements in a wireless access interface that are reserved for the transmission of reference signals, in accordance with certain aspects of the present disclosure;

FIG. 9 is a representation of a positioning occasion transmission, showing a location and a length of the positioning occasion transmission within the radio frames transmitted by an infrastructure equipment;

FIG. 10 is a representation of an example embodiment of the present disclosure, showing a simplified representation of a downlink transmission from an NTN infrastructure equipment carried by a satellite and a user equipment, which are used to determine or to verify a location of a communications device/user equipment;

FIG. 11 is a representation of downlink communications and communication timings between an NTN infrastructure equipment carried by a satellite and a user equipment according to an example embodiment of the present disclosure;

FIG. 12 is a representation of a connection procedure between a user equipment and a network according to an example embodiment of the present disclosure;

FIG. 13 is a representation of downlink and uplink communications and communication timings between an NTN infrastructure equipment carried by a satellite and a user equipment according to an example embodiment of the present disclosure;

FIG. 14 is a representation of an example embodiment of the present disclosure, showing a simplified representation of the communication between an infrastructure equipment carried by a satellite and a moving user equipment according to an example embodiment;

FIG. 15 is a representation of an example embodiment of the present disclosure, showing a message flow between a network, an NTN infrastructure equipment, and a UE according to a downlink example embodiment of the disclosure; and

FIG. 16A and FIG. 16B represent an example embodiment of the present disclosure, showing a message flow between a network, an NTN infrastructure equipment, and a UE according to an uplink example embodiment of the disclosure.

### DETAILED DESCRIPTION OF THE EMBODIMENTS

### New Radio Access Technology (5G)

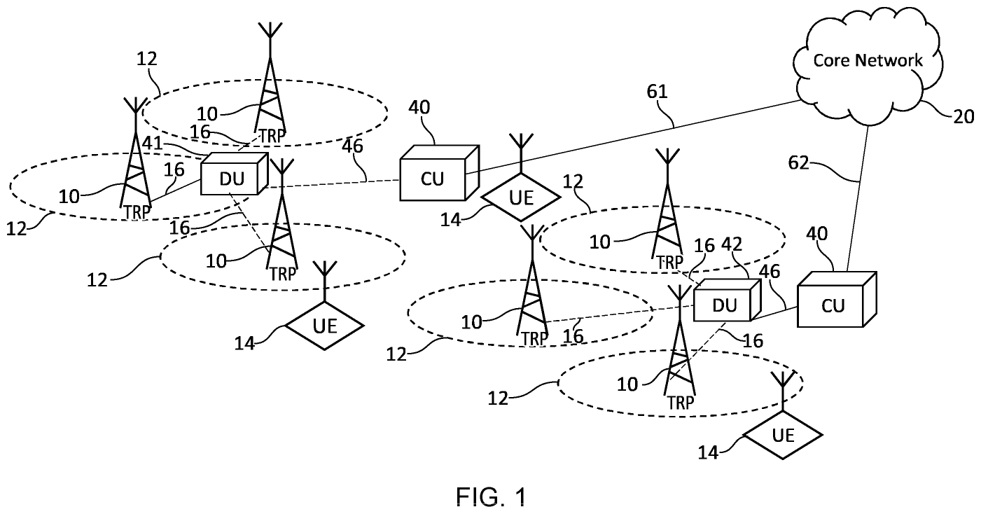

An example configuration of a wireless communications network which uses some of the terminology proposed for and used in NR and 5G is shown in FIG. 1. In FIG. 1 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

As will be appreciated by those acquainted with the wireless communications network according to a 5G standard as shown in FIG. 1, the CU 40, DU 42 and TRPs 10 collectively refer to functions which are conventionally performed by a network base station or, in accordance with 5G terminology, a gNB. As explained below, in an NTN network one or more of the components forming a gNB be may be mounted or located on a satellite. In terms of broad top-level functionality, the term network infrastructure equipment/access node may be used to encompass these elements and more conventional base station type elements of wireless telecommunications systems. Depending on the application at hand, the responsibility for scheduling transmissions which are scheduled on the radio interface between the respective DUs and the communications devices may lie with the controlling node/central unit and/or the distributed units/TRPs.

A communications device 14 is represented in FIG. 1 within the coverage area of the first communication cell 12. This communications device 14 may thus exchange signalling with the first CU 40 in the first communication cell 12 via one of the distributed units/TRPs 10 associated with the first communication cell 12. The communications devices 14 may be referred to as mobile terminals, terminals or user equipment (UE), which encompasses chip sets and have a functionality corresponding to the UE devices known for operation with wireless communications networks.

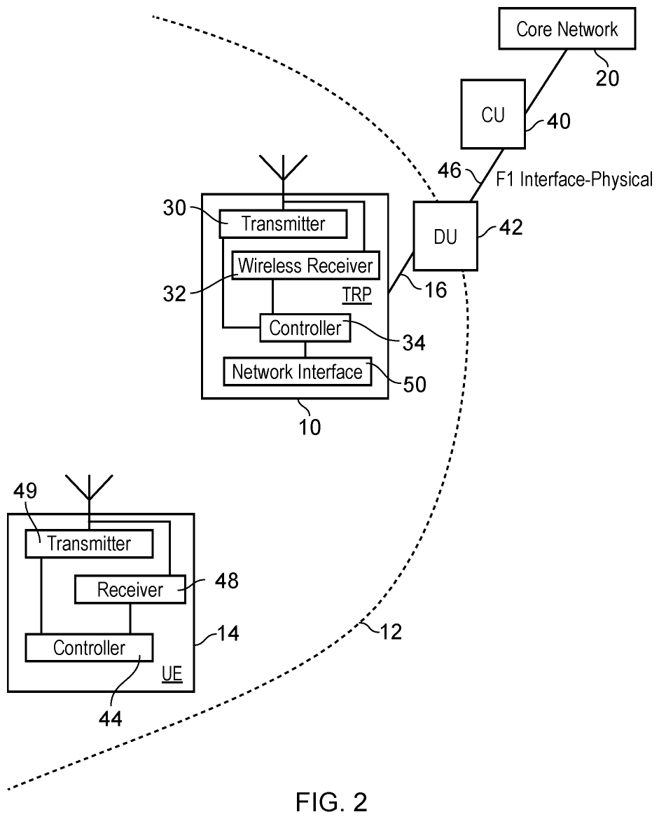

FIG. 2 provides a more detailed diagram of some of the components of the network shown in FIG. 1, with an indication of hardware components. In FIG. 2, a TRP 10 as shown in FIG. 1 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 2, an example UE 14 is shown to include a corresponding transmitter circuit 49, a receiver circuit 48 and a controller circuit 44 which is configured to control the transmitter circuit 49 and the receiver circuit 48 to transmit signals representing uplink data to the wireless communications network via the wireless access interface formed by the TRP 10 and to receive downlink data as signals transmitted by the transmitter circuit 30 and received by the receiver circuit 48 in accordance with the conventional operation.

The transmitter circuits 30, 49 and the receiver circuits 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controller circuits 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 2 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 2, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

### Non-Terrestrial Networks (NTNs)

An NTN aerial vehicle (such as a satellite or aerial platform) may allow a connection of a communications device and a ground station, which may be referred to herein as an NTN gateway [1]. In the present disclosure, the terms NTN aerial vehicle and NTN vehicle are used to refer to a space vehicle, aerial platform, satellite, or any other entity which moves relative to a communications device and is configured to communicate with a communications device. In particular, an NTN aerial vehicle may be in some embodiments a low earth orbit (LEO) satellite, a medium earth orbit (MEO) satellite, a high altitude platform system (HAPS), a balloon or a drone for example.

As a result of the wide service coverage capabilities and reduced vulnerability of space/airborne vehicles to physical attacks and natural disasters, Non-Terrestrial Networks are expected to:
foster the roll out of 5G service in un-served areas that cannot be covered by a terrestrial 5G network (isolated/remote areas, on board aircrafts or vessels) and underserved areas (e.g. sub-urban/rural areas) to upgrade the performance of limited terrestrial networks in a cost effective manner;
reinforce the 5G service reliability by providing service continuity for M2M/IoT devices or for passengers on board moving platforms (e.g. passenger vehicles-aircraft, ships, high speed trains, bus) or ensuring service availability anywhere especially for critical communications, future railway/maritime/aeronautical communications; and to
enable 5G network scalability by providing efficient multicast/broadcast resources for data delivery towards the network edges or even user terminal.

The benefits relate to either Non-Terrestrial Networks (NTNs) operating alone or to integrated terrestrial and Non-Terrestrial networks. These benefits include improving at least coverage, user bandwidth, system capacity, service reliability or service availability, energy consumption and connection density. A role for NTN components in the 5G system is expected for at least the following verticals: Transport, Public Safety, Media and Entertainment, eHealth, Energy, Agriculture, Finance and Automotive. It should also be noted that the same NTN benefits apply to 4G and/or LTE technologies and that while NR is sometimes referred to in the present disclosure, the teachings and techniques presented herein are equally applicable to 4G and/or LTE.

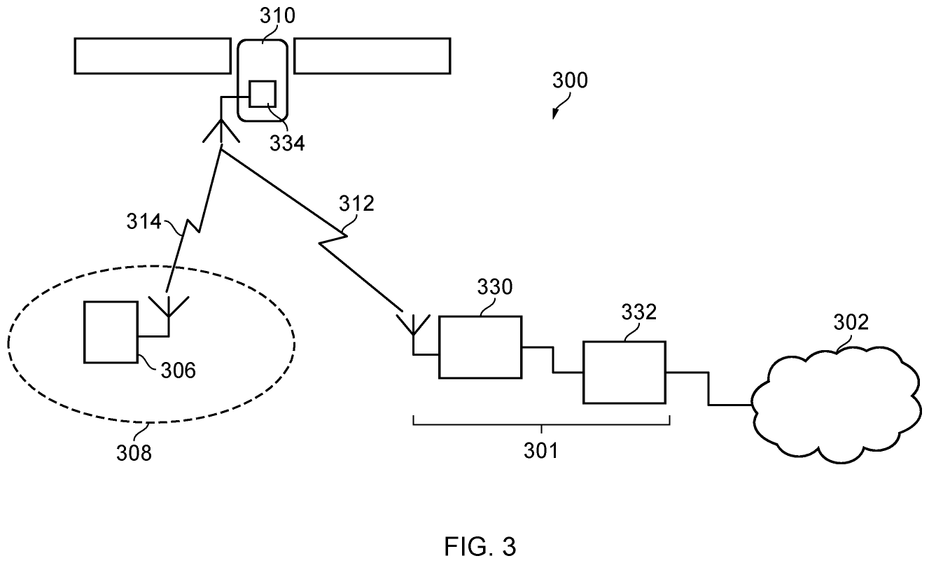

FIG. 3 schematically shows an example of a communications device 306 communicating with an NTN 300. The NTN 300 in FIG. 3 is based broadly around an LTE-type or NR-type architecture. Many aspects of the operation of the NTN 300 are known and understood and are not described here in detail in the interest of brevity. Operational aspects of the NTN which are not specifically described herein may be implemented in accordance with any known techniques, for example according to the current LTE-standards or the proposed NR standards.

The NTN 300 comprises a core network part 302 (which may be a 4G core network or a 5G core network) in communicative connection with a radio network part 301. The radio network part 301 comprises a base station 332 connected to a ground station (or NTN gateway) 330, which may be formed as separate equipment and connected as in the Figure, or may equally be formed as a single entity performing the functions of both the base station 332 and the ground station 330. The radio network part 301 may perform the functions of a TRP 10, DU 41, 42, or CU 40 of FIG. 1, or may more broadly perform the functions of a base station such as an eNB or gNB in accordance with 4G or 5G standards.

The NTN 300 comprises an NTN aerial vehicle 310 which includes communications circuitry 334 for communicating with the communications device 306 and radio network part 301 via wireless communications links 314, 312.

The communications device 306 is located within a coverage area (or cell) 308 provided by the NTN 300. In the example shown in FIG. 3, the coverage area 308 is provided by a spot beam generated by the communications circuitry 334 of the NTN aerial vehicle 310. The boundary of the cell 308 may depend on an altitude of the NTN aerial vehicle 310 and a configuration of one or more antennas of the communications circuitry 334 by which the communications circuitry 334 transmits and receives signals from the communications device 306.

The spot beam may be an “earth fixed beam” which covers a geographic area on a surface of the earth for a pre-defined period of time. Alternatively, the spot beam may be an “earth moving beam” which covers a constantly changing geographic area on the surface of the earth. In an example, the communications device 306 may determine, based on certain decision criteria, to switch from being served by an NTN aerial vehicle 310 that implements an “earth fixed beam” to an NTN aerial vehicle 310 that implements an “earth moving beam”, or may determine, based on similar criteria, to switch from being served by a NTN aerial vehicle 310 implementing an “earth fixed beam” to a “earth moving beam” provided by the same NTN aerial vehicle 310. It would be apparent that the communications device 306 is able to determine these changes in both directions, that is, it is able to determine to switch from a fixed beam to a moving beam, and vice versa, and to switch between NTN aerial vehicles 310 that connect the communications device 306 to the NTN 300.

In FIG. 3, the ground station 330 is connected to the communications circuitry 334 by means of a wireless communications link 312. The communications circuitry 334 receives signals representing downlink data transmitted by the radio network part 301 on the wireless communications link 312 and transmits signals representing the downlink data via the wireless communications link 314 providing a wireless access interface for the communications device 306. Similarly, the communications circuitry 334 receives signals representing uplink data transmitted by the communications device 306 via the wireless communications link 314 and transmits signals representing the uplink data to the ground station 330 on the wireless communications link 312. The wireless communications links 312, 314 may operate at the same frequency, or may operate at different frequencies.

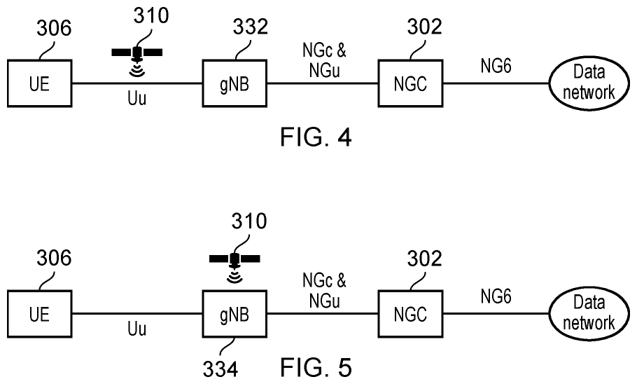

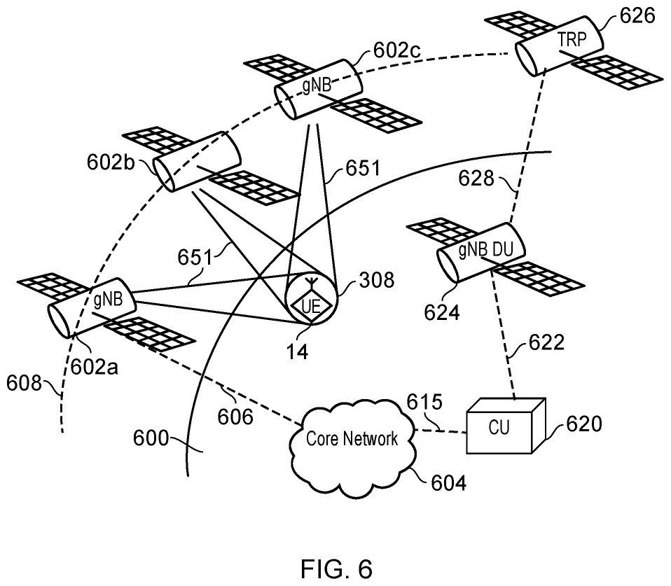

The extent to which the communications circuitry 334 processes the received signals depends on the processing capability of the communications circuitry 334 as explained in more detail with reference to FIGS. 4 and 5 below.

FIG. 4 illustrates an example of an NTN architecture based on the NTN aerial vehicle 310 operating in a transparent manner, meaning that a signal received from the communications device 306 at the NTN aerial vehicle 310 is forwarded (to the communications device 306, to a ground station 330 on Earth or to another NTN aerial vehicle) with only frequency conversion and/or amplification. In such implementations, a wireless access interface (such as an NR Uu interface) connecting the communications device 306 and the base station 332 located on the Earth is provided by the base station 332. In such implementations, the base station 332 may be regarded as “NTN infrastructure equipment”.

FIG. 5 illustrates an example of an NTN architecture where the communications circuitry 334 of the NTN aerial vehicle 310 implements at least some base station functionality. In such cases, the communications circuitry 334 is an example of “NTN infrastructure equipment”. The communications circuitry 334 generates the wireless access interface (such as an NR Uu interface) which connects the NTN aerial vehicle 310 and the communications device 306. For example, the communications circuitry 334 may decode a received signal, and encode and generate a transmitted signal. In other words, the communications circuitry 334 may include some or all of the functionality of a base station (such as a gNodeB or eNodeB). In some examples, latency-sensitive functionality (such as acknowledging a receipt of the uplink data, or responding to a RACH request) may be performed by the communications circuitry 334 partially implementing some of the functions of a base station. A wireless communications feeder link between the NTN aerial vehicle 310 and the ground station 330 may provide connectivity between the communications circuitry 334 and the core network part 302. In scenarios where the NTN aerial vehicle 310 implements at least some base station functionality, the base station 332 located on the Earth may not be present in the NTN 300.

As will be appreciated, the mobility of the coverage area 308 in NTNs can create technical challenges which may not occur in conventional terrestrial networks. For example, where the NTN aerial vehicle 310 is an LEO satellite, the NTN aerial vehicle 310 may complete an orbit of the Earth in around 90 minutes. In this case coverage area 308 generated by the NTN aerial vehicle 310 moves very rapidly with respect to a fixed observation point on the surface of the Earth (for example, an LEO may move at 7.56 km/s).

### Deployment of Network Elements as a Non-Terrestrial Network (NTN)

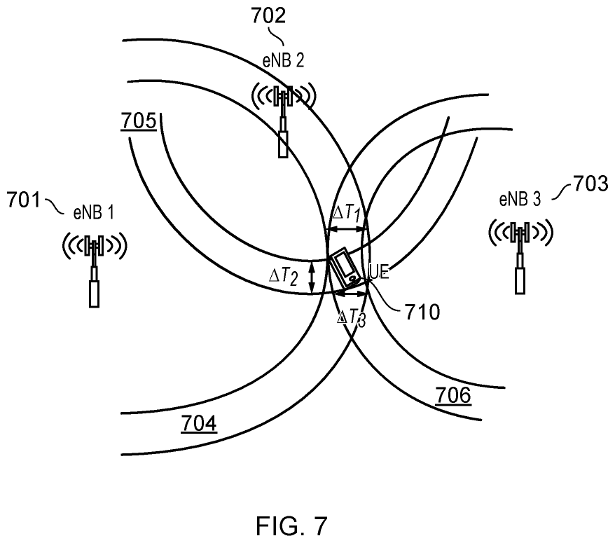

An example deployment of a 5G wireless communications network which may be used to improve coverage in some situations is a NR Non-Terrestrial Network (NTN), in which multiple satellites in orbit are used for LEO/MEO deployment with a transparent mode of operation. In transparent mode, the satellite functions as a “bent pipe” carrying RF signals, whilst the rest of the gNB functionality resides on the earth in terrestrial infrastructure equipments, connected via a ground station or an NTN gateway. However, there is an increased interest in regenerative satellites whereby the gNB or a part a gNB functionality resides in the satellite. The satellite could therefore carry a complete gNB functionality or each satellite could carry different gNB functionalities such as a CU, a DU or a TRP/Remote Radiohead (RRH). An example is illustrated in FIG. 6.

In FIG. 6, a plurality of satellites 602, 624, 626 are shown in orbit around the Earth 600 in which each satellite includes certain functionality of a gNB. For example, a first satellite 602 includes the functionality of a gNB and connects to the core network 604 on the ground by an Earth to satellite link 606. The first satellite 602 is represented at different time instances in its flight designated by 602a, 602b, and 602c, and collectively referred to as first satellite 602. A flightpath 608 signifies the flightpath of the first satellite 602, and representations 602a, 602b, and 602c are respective instances of the satellite at different points along the flightpath. A further example is shown in which CU 620 is located on the Earth's surface 600 and connected via an Earth to satellite link 622 to a gNB DU carried by satellite 624. The satellite 624 carrying the gNB DU is connected to a satellite 626 carrying a TRP via a communications link 628.

As will be appreciated from the following description, example embodiments can apply to both an NTN based gNB formed from a TRP 626 and gNB DU 624 combination or an example of an NTN vehicle carrying a complete gNB 602.

The gNB 602 may transmit from a communications circuitry (not shown) a beam 651, which covers and provides a wireless access interface for communications devices such as UE 14 in a cell 308 on the surface of the earth 600. It will be appreciated that, as the cell 308 is depicted in the same location on the surface of the earth 600 at successive instances of the flightpath of the satellite with gNB functionality 602, this example corresponds to an earth fixed beam example, as described above. This is not intended to limit the present disclosure to apply only to the earth fixed beams, but to include the earth moving beams also described above, with the necessary amendments made to the implementation of the enclosed details, as the skilled person would be able to apply them.

### Need for Verification of UE Location

As mentioned above, example embodiments can provide an improvement in determining or verifying a location of a communications device (UE) in order to provide location-based services to a UE. The location-based services could be, for example, determining a location of the UE by the network in order for the network to provide services specific to the UE's location, such as directing emergency services when a UE crosses a national boundary but is still communicating with a neighbouring network in another country. Likewise, an application programme running on the UE may provide certain services, having either determined the location of the UE or having been provided with a determined location of the UE. As will be appreciated, such location-based services depend on an accurate determination of a location of the UE.

It has been identified within 3GPP TR 22.296 [14] that to support regulated services and features, such as Public Warning Systems, Charging and Billing, Emergency calls, Lawful Intercept, Data Retention Policy in cross-border scenarios and international regions, and Network access, wireless networks should have the capability to locate each UE in a reliable manner and determine a policy that applies to their operation depending on their location. It is also suggested that a position determined and generated by the UE through its GNSS capability cannot be trusted by the network operator.

It is also stated in [3] that accuracy requirements for the UE location vary by application, for instance:

TABLE 1
UE location requirements for different location applications.

| Use case | Accuracy requirement |
|---|---|
| Emergency call | 50 m |
| Lawful intercept | Approx. 2 km |
| Public warning system | Approx. 2 km |
| Charging and tariff notifications | Approx. 2 km |
| (determination of which country the | |
| UE is in or the country/aeronautical/ | |
| maritime status of the UE) | |
| Country of UE location | A few kms (size of terrestrial cell) |

It should be noted that the accuracy in the above table for the Lawful intercept, Public warning system, and Charging and tariff notifications, that is 2 km, is equivalent to the accuracy obtainable in a terrestrial network using positioning through Cell ID, and that the applications may come with other requirements besides location accuracy, for example the Emergency call application may require a latency to be lower than for other applications. The latency requirement may be such that the setting up of the emergency call should not be delayed by location requirements [3]. It should also be noted that the accuracy requirement of the emergency call procedure, that is, 50 m, may not in some circumstances be achieved, and likewise the latency requirement that the setting up of the emergency call be not delayed. More information can be found in references [2] to [8], which contain further details on the need for network verification of the UE location.

A technical problem is therefore to improve a determination or verification of the location of a UE which is being served by an NTN. As background, which may be useful to understanding the description of example embodiments, the following paragraphs provide an explanation of techniques for locating communications devices which are used with terrestrial wireless communications networks.

### Observed Time Difference of Arrival (OTDOA)

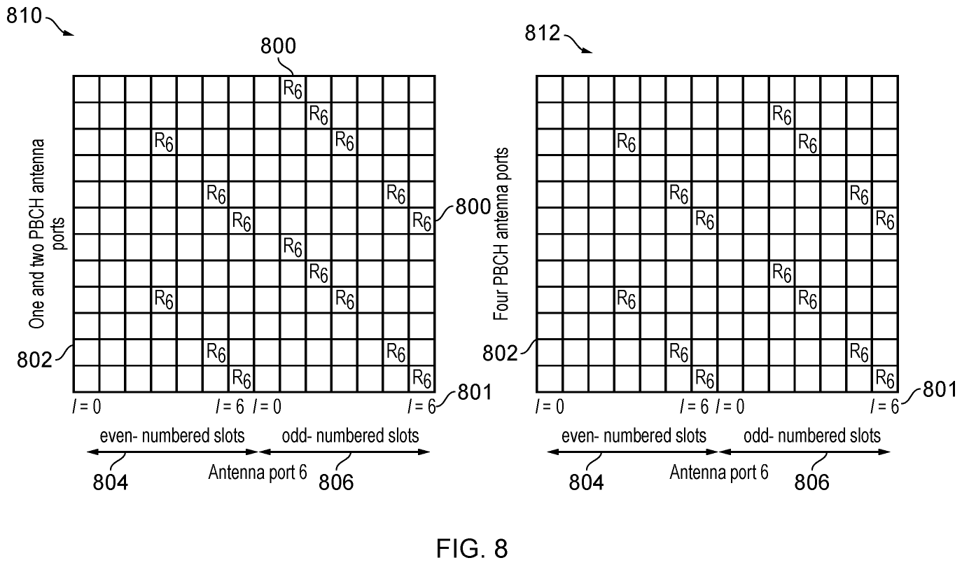

One of the positioning techniques considered for IoT (i.e. eNB-IoT and fe-MTC) is Observed Time Difference Of Arrival (OTDOA). This is a technique in which a location of a UE is determined from measurements of a time for signals to propagate between the UE and a plurality of gNBs/eNBs, from which the location of the UE can be determined by triangulation. This technique can be applied to either uplink or downlink signals. This is shown graphically in FIG. 7, which depicts three eNBs numbered 701, 702, and 703, and a UE 710.

A basic operation of calculating time of arrival (TOA) from each eNodeB, that is from downlink signals, can be described as follows:
1. First, a UE receives reference signals and then performs cross-correlation with locally generated reference signals.
2. Cross-correlation from different sub-frames can be accumulated so that good cross-correlation peaks can be obtained.
3. A measured time delay can be obtained from an estimated power delay profile (PDP), which may be reported as a relative time difference of arrival or as an absolute time.
4. The above steps are repeated to obtain measured time delays from several eNodeBs (e.g. reference eNodeB and neighbour eNodeBs).
5. Reference Signal Time Difference (RSTD) measurement is obtained by subtracting the measured time delay of neighbour eNodeBs from the measured time delay of the reference (serving) eNodeB. The UE may send all of the RSTD measurements and an RSTD measurement quality to a location server, or may process the RSTD measurements itself to determine its location.

In FIG. 7, the UE 710 may measure a Reference Signal Time Difference (RSTD), i.e. an observed time difference between a target eNB and a reference eNB. In this example, the UE 710 would measure RSTD for two or more eNBs, for example eNB2 702 and eNB3 703 (i.e. involving three or more eNBs since one of them is the reference eNB, in this example eNB1 701) and may then process the RSTD measurements or send these RSTD measurements to a Location Server (not shown). The Location Server, on receiving the RSTD measurements, may calculate a UE position based on these RSTD measurements using known locations of the eNBs involved. That is, the Location Server performs a triangulation (involving at least three eNBs) to determine the UE 710 position as shown in FIG. 7. A time difference report containing the RSTD measurements, to be sent to the Location Server, may be a conventional Reference Signal Time Difference (RSTD) report as specified for 3GPP LTE and NR systems.

Accuracy of the UE 710 position is dependent upon an accuracy of the RSTD measurements. For example, in FIG. 7, a time of arrival from eNB1 has an accuracy of ΔT₁, as signified by a band 704, representing a possible variation on measured relevant propagation difference from the base station, which in this example is the eNB1 701. Likewise, a time of arrival of eNB2 has an accuracy of ΔT₂, as represented by a corresponding band 705, and a time of arrival for eNB3 has an accuracy of ΔT₃, similarly being represented by a band 706. Evidently, the UE 710 is located at an intersection of these bands, determined by a time difference and hence a propagation distance from each of the base stations 701, 702, 703 transmitting to the UE 710. An accuracy of a time of arrival measurement is dependent upon a quality of the measured Reference Signal and a bandwidth of the Reference Signal.

For greater accuracy, corresponding measurements may be taken of a time difference of arrival of further signals from additional base stations not represented here. It will be appreciated that the signals transmitted by the base stations (eNBs 701, 702, 703) may or may not be simultaneous; if not simultaneous then an offset of the base stations' transmission times, or alternatively times of individual transmissions according to some shared time keeping system, may be provided to the UE to assist its calculation of the UE location.

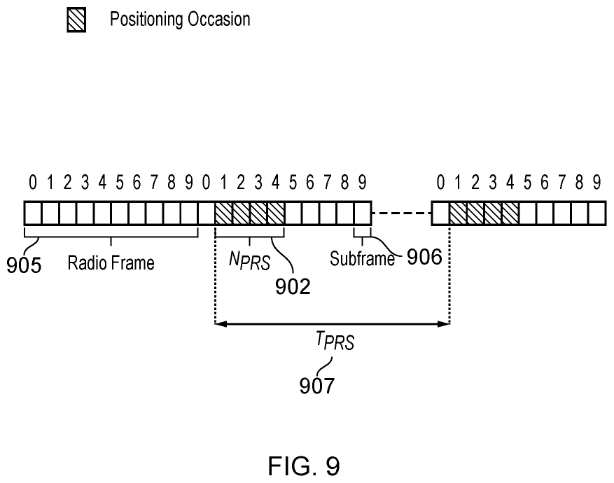

A time of arrival can be estimated using a known signal, i.e. Reference Signals (RSs) such as a Cell-specific Reference Signal, CRS, Primary Synchronization Signal, PSS, or Secondary Synchronization Signal, SSS. However, these RSs experience inter-cell interferences and hence in Rel-9, Positioning Reference Signals (PRS) are introduced. FIG. 8 shows a RE (Resource Element) location of a set of PRS for an eNB within a Physical Resource Block, PRB, and a location occupied is dependent upon an eNB's Cell ID. Up to six different sets of PRS locations with different frequency shifts can be transmitted, hence up to six different eNBs can be measured at a time if assuming one eNB per frequency shift. Note that eNBs sharing a same frequency shift would have different sequences to distinguish between themselves.

Specifically, FIG. 8 shows an example configuration of PRS locations R6 800 within a grid of possible time-frequency resource elements, the grid being a representation of OFDM symbols on an x-axis 801 and sub-carriers on a y-axis 802 defining resource elements as individual carriers. The OFDM symbols are grouped into slots 804, 806 comprising seven OFDM symbols. As shown in FIG. 8, two such grids are shown, one on a left side for one or two PBCH antenna ports 810 and one on a right side for four PBCH antenna ports 812. These two examples 810, 812, show different configurations that may be implemented, and are intended, though not limited, to represent the configurations employed corresponding to different numbers of antenna ports.

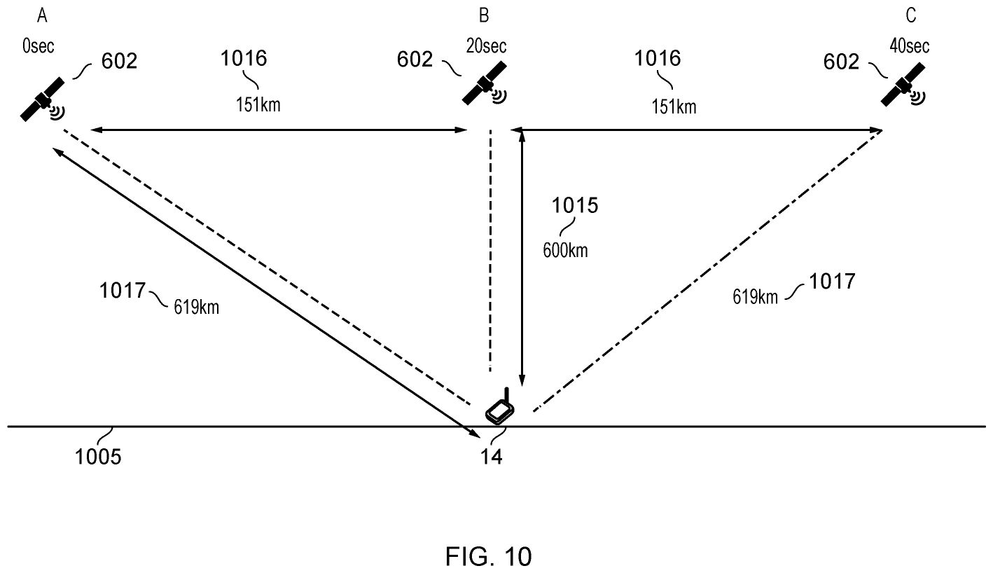

Furthermore, FIG. 9 provides an additional representation regarding a location of reference signals within frames broadcast by a base station. A set of consecutive subframes 902 are reserved for a transmission of reference signals, which are repeated with a periodicity T_{PRS} 907.

The PRS is transmitted over N_{PRS}={1, 2, 4, 6} consecutive subframes with a period of T_{PRS}={160, 320, 640, 1280} subframes. The N_{PRS} consecutive subframes of PRS transmission is known as a Positioning Occasion. An example of the Positioning Occasion and the period T_{PRS} are shown in FIG. 9, where the Positioning Occasion has length N_{PRS}=4 subframes and occupies subframe 1, 2, 3 & 4.

### Uplink Time Difference of Arrival

For the sake of completeness, further information will now be given about a process of a UE determining its location through an uplink time difference of arrival method, which, as described later, may be adapted to be implemented in accordance with several embodiments of the present disclosure. 3GPP NR also supports UTDOA (Uplink Time Difference of Arrival) and other positioning methods.

In Uplink Time Difference Of Arrival (UTDOA), a communications device transmits an uplink signal such as a Sounding Reference Signal (SRS) that is received by multiple infrastructure equipment. The SRS (uplink pilot) transmitted from the communications device may arrive at these infrastructure equipment at different times. The infrastructure equipment (which may be synchronised to each other, for example using a time derived from a GPS receiver) determine these times of arrival and may send these times of arrival to a location server. The location server calculates a location of the communications device based on multilateration.

It is well known in the art that a UE can determine its location by using a Global Navigation Satellite System (GNSS) such as GPS, GLONASS, or other suitable system. These systems, in a simplified way, work on a basis of triangulation of the device with respect to a plurality of satellites (typically four satellites are required) to determine a location of a receiving device such as the UE. However, it is required that a network should have some way of determining or verifying the location of the UE independently of the UE reporting its position. It is a regulatory requirement in some applications to provide techniques for a network to verify the location of a UE. If there are errors in the calculation of a UE's location, the difference between a UE's calculated location and its actual position may increase over time, causing substantial errors and leading to significant problems.

### Potential NTN Positioning Methods

A recent discussion [7] identified various candidate NTN positioning methods for a determination of a UE location in an NTN network. These methods include:
RAT-dependent positioning techniques, based on similar terrestrial network techniques
   Downlink Time Difference of Arrival, DL TDOA, also known as Observed TDOA, OTDOA
   Uplink Time Difference of Arrival, UL TDOA or simply UTDOA
   Round Trip Time, RTT
   Angle-based positioning methods (angle of arrival, AoA, angle of departure, AoD). It is observed that such positioning methods are not well suited to NTN due to the wide spot beams of the non-terrestrial elements of the NTN.
RAT-independent positioning methods, based on terrestrial network techniques
   Global Navigation Satellite Systems (GNSS)
   Assisted GNSS (A-GNSS)
   Terrestrial Beacon Systems (TBS)

In [4] it is observed that several terrestrial positioning techniques could be adapted to support verification of UE location using a single or multiple satellites. There are also a number of other techniques used to determine the locations of UEs in terrestrial networks, such as Sensors, WLAN, Bluetooth, Enhanced Cell ID (E-CID), the first three being dependent on external systems/sensors and network assistance, and E-CID being a legacy E-UTRA positioning method. Several of these are being adapted for use in future NR standards.

Current 3GPP specifications define functionality for identifying an absolute location of a UE or communications device (such as the communications device 14 of FIGS. 1 and 2 or UE 306 of FIG. 3) which is configured to operate in accordance with those specifications, and in communications with a wireless communications network operating according to those specifications. RTT uses measurements of a round-trip time of signals between the communications device and multiple infrastructure equipment to determine a distance between the communications device and each of the multiple infrastructure equipment, from which a location corresponding to the communications device can be derived.

The above technique, as well as OTDOA and UTDOA, rely on a measurement (of a signal strength and/or of a relative time of arrival) of signals transmitted by the communications device 14 and received at infrastructure equipment of the wireless communications network, or of signals transmitted by the infrastructure equipment and received at the communications device 14.

Further details of 3GPP positioning methods are provided in [11].

The UE can determine its location via various RAT-independent means such as GPS/GNSS as discussed above. These location methods are known as being accurate. If the network itself were capable of accurately locating the UE, there would be no point in the UE sending its own positioning report. The role of network verification of UE location is not to compete with traditional positioning methods, such as GPS, but to verify a location of the UE reported by the UE to the network.

### Number of Measurements Required to Verify UE Location

GPS requires four measurements in order to determine the {latitude, longitude, altitude} of a communications device. Determining a GPS location requires the following steps:
UE receives reference signals from four or more satellites
UE calculates an RSTD (reference signal time difference) or time of flight from each of the satellites
Knowing a location of each of the satellites (via ephemeris information) and a synchronisation state of the satellites (e.g. that the satellites are synchronised), the UE can multilaterate in order to determine its location. In some situations, if the satellites are not synchronised, the UE may offset the RSTD of some or all of the satellites based on a known timing difference between the satellites.

In contrast, for UE location verification, it may not be necessary to determine an altitude of the UE. In this case, {latitude, longitude} can be determined with three measurements. UE location verification hence requires fewer measurements than position determination, and indeed may not need to be determined to the same level of precision as an initial UE location determination.

In NTN systems, at any one time, the UE may only be able to see a single (or limited number of) satellites. This makes it difficult to perform traditional OTDOA or UTDOA positioning methods for the purposes of UE location verification. A RAT-dependent UE-location verification method that can operate with a single satellite is hence desirable.

It should be possible to operate the UE location verification method for a variety of UE speeds, for example, up to 500 kmph.

Embodiments of the present disclosure thus provide for a method and apparatus to determine accurately the location of a UE based on measurements of the distance of the UE from a single satellite.

Example embodiments can provide a method by a UE comprising receiving, from a NTN infrastructure equipment forming part of a wireless communications network, a first signal, the first signal having been transmitted when the NTN infrastructure equipment is in a first orbital location, determining a first measurement based on the received first signal, receiving, from the NTN infrastructure equipment at a time later than a time of the reception of the first signal, at least one further signal, the at least one further signal being received when the NTN infrastructure equipment is in a different orbital location to the first orbital location, and determining at least one further measurement based on the received at least one further signal. The method further comprises transmitting an indication for determining a relative difference between the determined first measurement and the determined at least one further measurement to the wireless communications network over a wireless access interface provided by the wireless communications network for the wireless communications network to verify a reported location of the communications device based on the indication of the determined first and at least one further measurements caused by the NTN infrastructure equipment being in the first and the one or more different orbital locations when the first signal and the at least one further signal were transmitted. As explained below, in one example the NTN infrastructure equipment mounted on a satellite may transmit a signal periodically which is detected by the UE. However, in another example embodiment, the signal is not transmitted periodically, but at a time that the UE is informed of such that the UE may receive the signal. By comparing a time of reception of the signal, a relative difference in a location of the NTN infrastructure equipment at a time of transmitting the signal can be used to determine a difference in distance between the UE and the NTN infrastructure equipment at a time when the signal was transmitted. Since the wireless communications network will know the location of the NTN infrastructure equipment, when the signal is transmitted, a location of the UE can be determined or verified based on a time difference of arrival of that signal at the UE. As will be appreciated, depending on a velocity of the NTN infrastructure equipment and a time between transmission of the first and the at least one further signal, a difference in an orbital location of the NTN infrastructure equipment can be significant, thereby increasing an accuracy with which the location of the UE can be estimated. Further example embodiments will now be explained.

Measuring DL Reference Signals from the Satellite at Different Times

A Low Earth Orbit (LEO) satellite traverses the sky rapidly. For example, when in a 600 km altitude orbit, a LEO satellite moves at 7.56 km/second. Therefore, if reference signals with reference to a same satellite are measured at different times, resulting reference signal measurements will be taken with the same satellite at different orbital locations (positions in the sky).

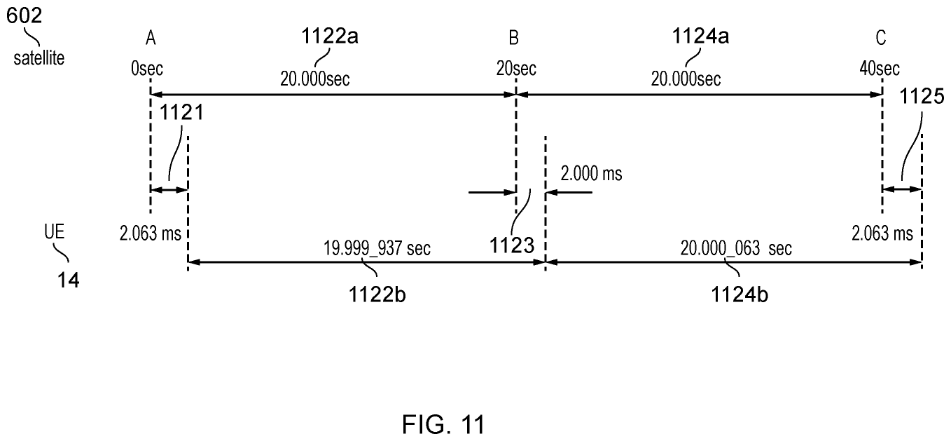

FIG. 10 shows a simplified representation of the satellite shown in FIG. 6 for an example configuration of a LEO satellite 602 and distances between the satellite and a UE 14. The LEO satellite 602 in this example operates at an altitude of 600 km. As noted above, a LEO satellite 602 in such an orbit travels at 7.56 km/sec and hence moves 151 km 1016 in 20 seconds. Hence, a distance between the satellite 602 and UE 14 varies from 619 km 1017 to 600 km 1015 (by basic trigonometry), when the satellite 602 moves from position A to position B. It is considered that the UE 14 is on the surface of the earth 1005, which is modelled as a flat plane, and that any motion of the UE 14 is insubstantial in comparison to a velocity of the satellite 602.

As will be appreciated, FIG. 10 is a simplified representation of a movement of an NTN vehicle in that the movement and distances shown are represented as linear whereas in practice the NTN satellite 602 would move in an arc and the Earth's surface would be an arc as represented in FIG. 6. However, without loss of accuracy the principles adopted by the present technique can be simplified to the linear representation in FIG. 10.

By approximating the speed of light as 3×10⁸ m/s, a time of flight for a signal from the satellite to the UE, corresponding to a transmission distance of 619 km, 600 km, and 619 km respectively, at the various times can be calculated to be:
A (0 seconds): 2.063 ms
B (20 seconds): 2.000 ms
C (40 seconds): 2.063 ms

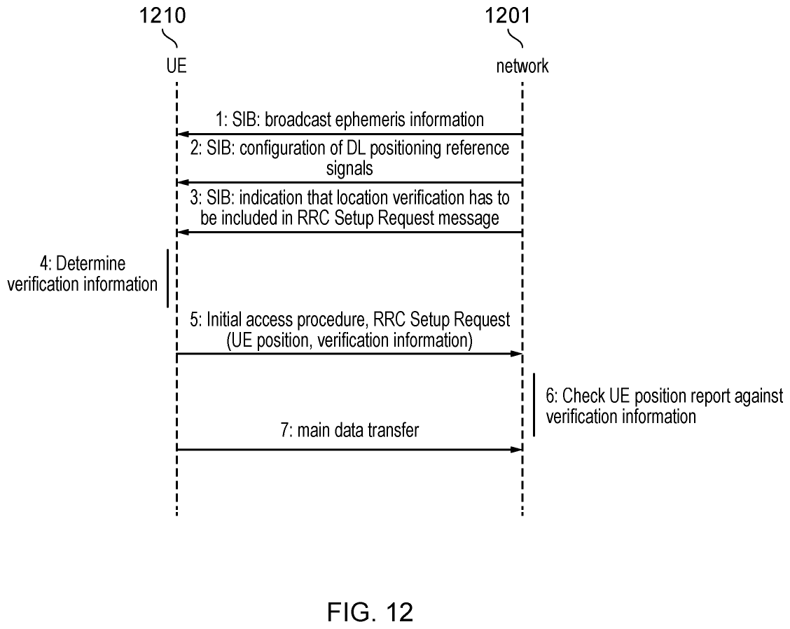

FIG. 11 shows a representation of a timing of signals, times of transmission for signals by a satellite 602, and corresponding times of arrival at the UE 14 of DL reference signals that are transmitted by the satellite 602 at times 0, 20 seconds, and 40 seconds in a similar way to the PRS as explained above for a terrestrial gNB. The times of arrival at which the DL reference signals are received at the UE 14 are delayed, relative to transmit times at the satellite 602, due to varying propagation times that are shown in FIG. 11.

Instances A, B, and C (in bold) correspond to positions of the satellite at locations A, B, and C in FIGS. 6 and 10. At A, the satellite 602 transmits a signal to the UE 14 and a delay 1121 is 2.063 ms as shown in FIG. 11. The satellite 602 waits 20 seconds 1122a before transmitting a second signal to the UE 14, at which time the satellite 602 has moved to position B. At this point, the satellite 602 transmits a second signal to the UE 14, which, because the satellite 602 has moved to a position closer to the UE 14, has a lower propagation delay 1123. Thus, a time difference 1122b between a reception of the first and second signals by the UE is lower than a time difference between the respective signal transmission times by the satellite 602.

This is reversed when the satellite 602 travels from position B to position C, as the time of flight for the signals increases. Due to the locations of C and A being equidistant from the UE 14, the time of flight for C 1125 is the same as for A 1121. The satellite 602 having travelled through position B continues to position C, and again waits 20 seconds 1124a before transmitting a third signal to the UE 14. The distance between the satellite 602 and the UE 14 increasing causes a time difference at the UE 14 between a reception of signals transmitted by the satellite 602 at B and at C to increase, so the time difference for this example is 20.000063 seconds.

Based on reception times of these signals, in one example, the UE would report the following inter-arrival times of these transmitted signals:
AB: 19.999937 seconds
BC: 20.000063 seconds

[Note that an exact form of signaling used can differ from that shown above. For example, the UE can signal a difference (delta) of the inter-arrival times from an inter-transmit time of 20 seconds. i.e. the UE can report times of {AB: −0.063 ms, BC: +0.063 ms}, which are the differences in the inter-arrival times].

The network can calculate a location of the UE 14 based on a known position of the satellite at the different transmit times of the reference signals i.e. at positions A, B, and C, and the time difference of arrival of the reference signals, where a relevant TDOA in the example shown in the figures above is {AB: −0.063 ms, BC: +0.063 ms}. Methods of calculation of UE position based on time difference of arrival and known gNB locations are described above for currently specified DL-OTDOA techniques for terrestrial networks. Time difference of arrival with reference to two signals can be calculated as a difference between an interarrival time for two signals and an inter-transmit time of the same two signals. An interarrival time is the time difference, as measured by a receiving body (that is, the UE, in the downlink example), between reception of two signals. An inter-transmit time is the time difference, as measured by a transmitting body (that is, the satellite, in the downlink example), between transmission of two signals.

Alternatively, an interarrival time may be calculated between a reception of a signal at a receiving body and a reference time, for instance a reference time on a clock at the UE, having been synchronized with a clock on the satellite or that is known to be accurate (e.g. an atomic clock). In this example, only one signal is needed, since the difference is taken between the one received signal and the reference time.

A reference signal is a signal from which a time of arrival or other measurement may be determined. Examples of the DL reference signals could include:
Positioning Reference Signal, PRS
Channel State Information Reference Signal, CSI-RS
Synchronization Signal Block, SSB
Tracking Reference Signal, TRS

Or other such suitable signals.

Note that this positioning method can be used with more than one satellite, provided the network knows a timing of the DL signals from the satellites and locations of the satellites.

Note that an accuracy of TDOA measurements depends on an accuracy of a clock at the UE for a period of observation when the signals are transmitted between the UE and the satellite.

### Signalling of TDOA

The UE 14 can signal the TDOA measurements via RRC or MAC signalling.

The TDOA measurements can be signalled either (referring to FIG. 11):
After every reference signal is received. In this case, TDOA measurements would be signalled at times when the satellite is at position ‘B’ and ‘C’.
After a set of reference signals is received. In this case, TDOA measurements would be signalled after time C, where two TDOA measurements would be signalled: {TDOA between A and B, TDOA between B and C}

The configuration information of DL reference signals to be used for network verification of UE location may be signalled in system information. This configuration information may contain resource allocation information of time and/or frequency resources at which the DL reference signals are transmitted.

In some embodiments, the network can signal an indication that location verification information has to be included in an RRC Setup Request message. This signalling could be carried in system information.

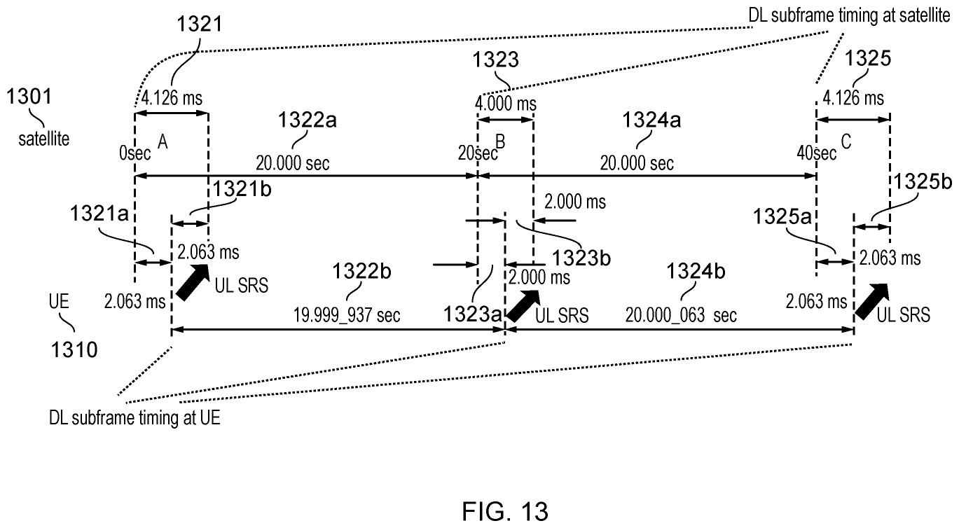

FIG. 12 shows an example signalling procedure for UE 1210 location verification using DL reference signals. In step 1, the network 1201 sends to the UE 1210 a system information block (SIB) containing ephemeris information for a satellite with which the UE 1210 is able to exchange signals. In this example embodiment, the UE 1210 is only able to exchange signals with one satellite, but the present disclosure is not to be limited to such a scenario. If the UE 1210 is able to exchange signals with more than one satellite, then the network 1201 may send at this stage ephemeris information relating to more than one satellite. Current 3GPP standards allow for the network to send satellite ephemeris information related to 4 satellites to a UE.

In step 2, the network 1201 sends to the UE 1210 a further system information block containing a configuration of resource elements for transmission and reception of downlink reference signals. The UE 1210 is thus made aware of reference signals to be transmitted to it, and of their time and frequency allocations. In step 3, a further SIB is sent to the UE 1210 by the network 1201, which includes an indication that the UE 1210 location verification should be included within any RRC Setup Request message.

In step 4, the UE determines from the downlink reference signals the location verification information that the network needs included in any RRC Setup Request.

In step 5, the UE 1210 then attempts to setup an RRC Connection with the network 1201. This may involve the UE 1210 transmitting to the network 1201 its location determined by GNSS, the location verification information determined in step 4, data which might allow the network 1201 to verify the location of the UE 1210 such as TDOA measurements, or other verification information as requested by the network 1201 and so on in addition to the standard contents of an RRC Setup Request.

Following this, in step 6, the network 1201 may check a UE location report (determined, for example by using GPS or another GNSS) against the verification information provided to it. If an outcome of this check is satisfactory, a main data transfer between the UE 1210 and the network 1201 may commence, as seen in step 7.

It should be appreciated that some of these steps may be omitted from the process outlined above, or may be performed in an order different to the order of the process above, or indeed other steps may be included within this process. For example, the system information blocks may be transmitted in a different order to the order above or there may be a step of communicating to the UE 1210 a success of the position report check carried out by the network in step 6.

Measuring UL Reference Signals from the UE at Different Times

Example embodiments can also provide a method performed by a communications device (user equipment, UE) comprising transmitting, to a non-terrestrial network (NTN) infrastructure equipment forming part of a wireless communications network, a first reference signal via a wireless access interface of the wireless communications network formed by the NTN infrastructure equipment, the first reference signal being transmitted at a time determined from a reference forming part of the wireless access interface such as a frame boundary, a subframe boundary, or other reference, and the first reference signal is transmitted when the NTN infrastructure equipment is in a first orbital location. The method includes transmitting, to the NTN infrastructure equipment at a time later than a time of the transmission of the first reference signal, at least one further reference signal via the wireless access interface, the at least one further reference signal being transmitted at a time determined from a reference forming part of the wireless access interface, the at least one further signal being transmitted when the NTN infrastructure equipment is in a different orbital location to the first orbital location. A difference in an arrival time of the first reference signal and the at least one further reference signal with respect to the reference of the wireless access interface can be used to determine or to verify by the wireless communications network a location of the communications device based on measurements determined by the NTN infrastructure equipment, the difference in an arrival time being caused by the NTN infrastructure equipment being in different orbital locations when the first reference signal and the at least one further reference signal were transmitted. Thus determining a difference in arrival time of the first reference signal and the at least one further reference signal while knowing when those signals were transmitted, or a difference in time of the first reference signal and the reference forming part of the wireless access interface, a location of the UE can be determined or verified.

UL TDOA techniques (or round trip time, RTT, measurements techniques) can also be used, where a UE transmits some UL reference signals, such as a Sounding Reference Signal, SRS, or an UL channel, such as a Physical Random Access Channel, PRACH, and a network measures a time of arrival of these UL reference signals at a satellite. RTT techniques are more resilient to an issue of clock drift at the UE since time difference of arrival of the UL reference signals can be measured even when a UE's clock is synchronized to DL frame timing.

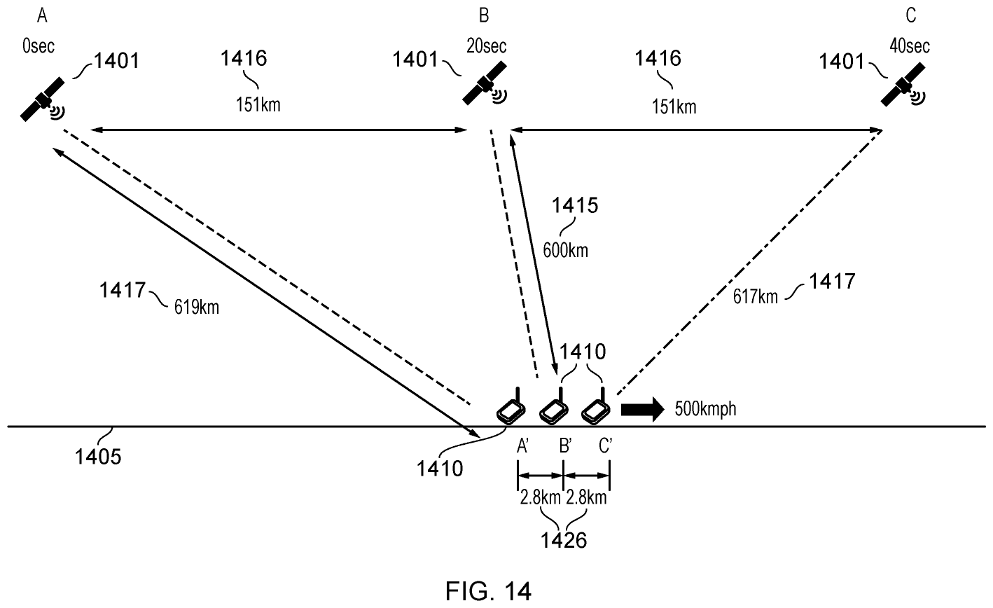

Operation of positioning/UE location verification using UL reference signals and RTT techniques is shown in FIG. 13. FIG. 13 is based on the scenario shown in FIG. 10.

In FIG. 13, a UE 1310 is instructed to send UL SRS at a known time relative to DL subframe timing. For the sake of simplicity, it can be considered that the UE 1310 is required to send to a satellite 1301 UL SRS immediately after downlink subframe boundaries that occur at times 0, 20 seconds and 40 seconds. The UE 1310 knows when these DL subframes boundaries occur, based on signalling of system frame number (SFN) and the UE 1310 being able to count subframes. The following transmissions and measurements occur:
With respect to position A, a DL subframe timing at the UE 1310 is 2.063 ms later than a DL subframe timing at the satellite 1301 due to a time of flight delay between the two 1321a. At the UE's DL subframe timing, the UE 1310 sends UL SRS. Since the UE's DL subframe timing is 2.063 ms late compared to the DL subframe timing at the satellite 1301, the UL SRS is transmitted 2.063 ms later than the satellite's DL subframe timing. The UL SRS is subject to a further propagation delay 1321b of 2.063 ms and hence arrives at the satellite 1301 4.126 ms after the satellite's DL subframe timing. The satellite 1301 can measure a 4.126 ms delay 1321 of the UL SRS reception, which represents a round trip time from the satellite 1301 to the UE 1310. Hence, a propagation delay between the satellite 1301 and UE 1310 can be calculated as 4.126/2=2.063 ms, which equates to a distance of 619 km. Following this, the satellite 1301 can send this data to a network, for instance to a gNB or other base station that controls the satellite 1301 and the transceiver functionality of the satellite 1301, and thus the network then knows that the UE 1310 is 619 km away from a location of the satellite 1301 at time 0 seconds. The network knows the location of the satellite 1301, either from signalling from a satellite ground station or from orbital calculations. Alternatively, the gNB can measure the delay between DL subframe timing and SRS reception and calculate the propagation time between the UE and satellite, having taken into account any delay on a feeder link between the gNB and satellite.
For position B, a similar RTT calculation to that undertaken at “A” can be done. At B, the satellite 1301 is closer to the UE 1310 (e.g. directly overhead) and an RTT is lower. At B, the RTT is measured as 4.000 ms, from an addition of a time by which the UE's subframe timing trails the satellite's subframe timing and a time of flight between the satellite 1301 and the UE 1310, equating to a distance of 600 km between the UE 1310 and satellite 1301.
At C a similar RTT calculation to that undertaken at “A” can be done. At C, the satellite 1301 is the same distance from the UE 1310 as at “A”. At C, an RTT is measured as 4.126 ms, equating to a distance of 619 km between the UE 1310 and satellite 1301. At “C”, the satellite 1301 is at a significantly different location to when it was at “A”, due to an orbital trajectory of the satellite 1301, despite the RTT being the same as measured whilst at A.
Based on (1) measured distances between the UE 1310 and satellite 1301 at times “A”, “B” and “C” and (2) known locations of the satellite at times “A”, “B” and “C”, the network can triangulate the location of the UE 1310.

### Timing Advance of UL Signals

UL signals used in this embodiment may be timing advanced. A network can then determine a propagation time between a UE and satellite as a sum of a propagation time derived from a timing advance applied to the UL signals and a difference between a received UL signal and DL subframe timing. There are a number of different configurations that might be employed. For instance, as part of current (Rel-17) NTN operation, the network can signal a common timing advance that the UE is to apply. In rel-17, the UE then applies an additional UE-specific timing advance in addition to this common timing advance. In the following embodiments, the UE can apply a common timing advance only or can apply a UE-specific timing advance or can apply both a common timing advance and a UE-specific timing advance.

The common timing advance applied for UE location verification may be a Rel-17 common timing advance, where additional UE-specific timing advance is not applied. That is, if a UE knows that UL signals are to be used for verification location, the UE might only apply the common timing advance for those UL signals. For other UL signals, the UE could apply both UE-specific and common timing advances, according to signalling associated with those other UL signals. If the UE applies a correct UE-specific timing advance correction, this is more likely to result in the UL signals reaching a receiver at an intended time, being received correctly, and not causing interference with other signals at the same time.

Signalling (e.g. RRC signalling) that informs UEs of UL signals to be used for location verification may be Rel-18 signalling. Rel-18 UEs are expected to be able to interpret this signalling, and UEs of earlier releases would not interpret the signalling. Hence, legacy UEs would apply appropriate timing advance to legacy signals and would not apply a timing advance like that described here to Rel-18 location verification UL signals.

In some example embodiments, a common timing advance is a value that is applied specifically for the purposes of UE location verification. In this embodiment, a network signals a value of common timing advance that a UE is to apply that is specific to the purposes of UE location verification. For example, the common timing advance may be a timing advance that is accurate for a UE at the centre of a satellite beam on Earth. Such a value of timing advance would ensure that for any UE within the satellite beam, a maximum delay of an UL signal is a time of flight corresponding to a propagation distance from a furthest edge of the beam to a satellite that is receiving the UL signals, because there is no additional bulk delay for the UL signal.

Alternatively, a UE may apply a timing advance signalled to it by a network. For instance, when the network instructs a UE to send an UL signal, the network may also indicate the timing advance to apply to that signal. For example, the network can determine a timing advance value that would be appropriate for an initially reported UE location (i.e. a location that needs to be verified). In this case, the network would be expecting an UL signal to arrive at a known time-if the UL signal were received at a different time, the initially reported UE location would not be verified.

In a separate embodiment, after transmission of an UL signal, a UE could indicate an UL timing advance that it applied to the UL signal. Following transmission of the UL signal that is used for location verification, the UE signals an indication of the timing advance that it had applied to that UL signal. A network receiving this indication can then determine a complete propagation time based on the UL timing advance and a timing of the received UL signal.

Note that in Rel-17, the UE may be required by the network to send a timing advance report, in order to inform the network of a timing advance applied. This timing advance report could be signalled periodically or be event-triggered e.g. an event is that the timing advance changes beyond a threshold. According to this embodiment, an additional event could be that the UE had just recently transmitted UL signals for location verification.

In another embodiment, a UE may signal an UL timing advance applied, but it waits before transmitting other UL signals. The UE can send a message with the UL timing advance applied to it in a Physical Uplink Shared Channel, PUSCH, message. A network can measure a timing error in the received PUSCH and add this to the UL timing advance applied in order to determine a propagation time. This embodiment is based on the observation/insight that the PUSCH itself can be used to measure a timing of the signal received from the UE (a separate UL signal is not required).

In an example, a message transmitted in PUSCH may be the Rel-17 message that indicates UL timing advance and it is either sent periodically or is event-triggered. In other words, a UE transmits a PUSCH carrying a message indicating the UL timing advance and a network measures a timing misalignment of the message after having received it. A distance between a satellite and the UE is calculated based on the signalled UL timing advance and the measured timing misalignment.

In general, a network can perform some verification of UE location by measuring/monitoring a timing advance that is applied to signal transmissions (the network may be able to control this by sending timing advance commands to a UE where the UE then performs the actual timing advance), where UL signals being timing aligned may indicate that a correct UE-specific timing advance has been applied, and thus that the UE is in the position that it has reported. In Rel-17, the UE determines its location from GNSS and determines a location of the satellite from ephemeris information. Based on these measurements of location, the UE applies a UE-specific timing advance. If the UE-specific timing advance is calculated correctly, a transmission from the UE should be timing aligned at the network (gNB) with transmissions from other UEs. If there were a consistent drift of the timing of the received UL signals from a particular UE, this would indicate that the UE is not in a location that it reported (which might mean that the UE could not correctly calculate its UE-specific timing advance).

Hence, in this embodiment:
The network verifies UE location when received UL signals are consistently timing aligned
The network may flag a fail of verification of UE location when there is a drift of a received timing of UL signals.

In other example embodiments of the present disclosure, UL signals may not be timing advanced. In the case that the UL signals are not timing advanced, the network ensures that any potential period of time (window) in which UL signals can be received is sufficiently wide to accommodate a maximum possible variation in reception time of the UL signals (accounting for UEs that are closest to a satellite receiving the UL signals and those that are furthest away). The window would also take into account a variation in a propagation time for any DL signal that schedules the UL signals (e.g. a Physical Downlink Control Channel, PDCCH, that schedules the UL signals) since a time of arrival of these signals at the UE would also depend on propagation time.

In some embodiments, after receiving, by a non-terrestrial infrastructure equipment, one or more signals from a UE, a base station, forming part of the non-terrestrial infrastructure equipment or to which the non-terrestrial infrastructure equipment has transmitted the information contained in the signals, and being in communication with the UE, might report to a wireless communications network information related to the UE such as a location of the UE, an Uplink Time of Arrival corresponding to the signals sent by the UE and/or a time of transmission of downlink signals sent by the infrastructure equipment, a Round Trip Time corresponding to communication with the UE, or other information that may assist the network in verifying the location of the UE. It may do this using some dedicated communications resources, over an air interface provided by the network, or another suitable medium for communication between the non-terrestrial infrastructure equipment and the wireless communications network. Furthermore, the non-terrestrial infrastructure equipment may signal to the wireless communications network information relating to the UE after a single signal from the UE is received by the non-terrestrial infrastructure equipment, or it may do so only after a set of signals have been received.

For uplink communication, a reference signal is defined, as for downlink communication, as a signal from which a time of arrival can be determined. In the Uplink case, examples include:
Sounding Reference Signal, SRS
Demodulation Reference Signal, DMRS.
Physical Random Access Channel, PRACH

Or other such suitable signals.

### Measurement/UL Signal Periodicity

A periodicity of measurements or UL signal transmission depends on one or more of:
UE speed. When a UE is travelling at high speed, a period of the measurements may need to be reduced (i.e. a time between measurements/UL signals may be reduced). This may be necessary as a reported UE location (the location that needs to be verified) will change more quickly if the UE is moving quickly.
Orbital speed of satellite. Note that while there is little difference in an orbital speed of LEO satellites (the orbital speed of a LEO-600 satellite is similar to an orbital speed of a LEO-1200 satellite), Medium Earth Orbit, MEO, (2000-36000 km above sea level) and Geostationary Orbit, GEO, (approx. 36000 km above sea level), satellites can have significantly lower orbital speeds. An orbital speed of a satellite will affect the periodicity required for the measurements/UL signals (slower satellites would mean that measurements/UL signals would have to be spaced further apart in time to allow for good multilateration). It should be noted that certain aspects of the present disclosure may not be applicable to GEO satellites, as the skilled person would be able to understand based on their technical knowledge.
Orbital height of satellite. A LEO-1200 satellite has approximately the same speed as a LEO-600 satellite, but has an orbit with twice the altitude above the Earth's surface. Hence, angles used in any triangulation calculations for the LEO-1200 satellite are smaller than for the LEO-600 satellite, and thus a difference in UE-satellite distance is reduced which may lead to a loss of accuracy in a position estimation obtained from LEO-1200 satellites when compared to the same procedure carried out with a LEO-600 satellite. In order to have a similar accuracy, triangulation angles for the LEO-1200 satellite may need to be increased by increasing a period of the measurements. In summary, for satellites in higher orbits, the period of the measurements may need to increase.
   Verification of UE Location without Triangulation

Above embodiments have discussed triangulation/multilateration of UE location based on measurements received from a UE or based on measurements of signals transmitted from the UE. It is however not necessary for a network to triangulate the UE location to perform verification. Provided the network measures and validates sufficient time of flight/propagation time measurements between a satellite and the UE, the network can verify the UE location. For example, referring to FIGS. 10 and 11, provided that the network receives propagation time estimates of 2.063 ms, 2.000 ms and 2.063 ms, the network can verify that the UE location which was reported to the network is correct.

In other words, the network can calculate propagation times that would be associated with the UE being in its reported location. If the network receives verification measurements that are consistent with those calculated propagation times, the UE location that was reported may be considered to be verified.

### Signalling of Location and Verification Information for High Speed UEs

For high speed UEs, it may not be possible to collate sufficient verification information before the UEs have moved a sufficient distance that the verification information is obsolete. In other words, there is no point trying to verify a location of a UE to an accuracy of ‘x’ metres if the UE can have moved by more than ‘x’ metres during the time required to perform the verification.

In order to counteract this issue, the UE can report position estimates along with verification information. For example:
The UE could signal {latitude/longitude, DL-TDOA measurement}
The UE could signal its updated latitude/longitude every time it transmits an UL reference signal used for verification purposes

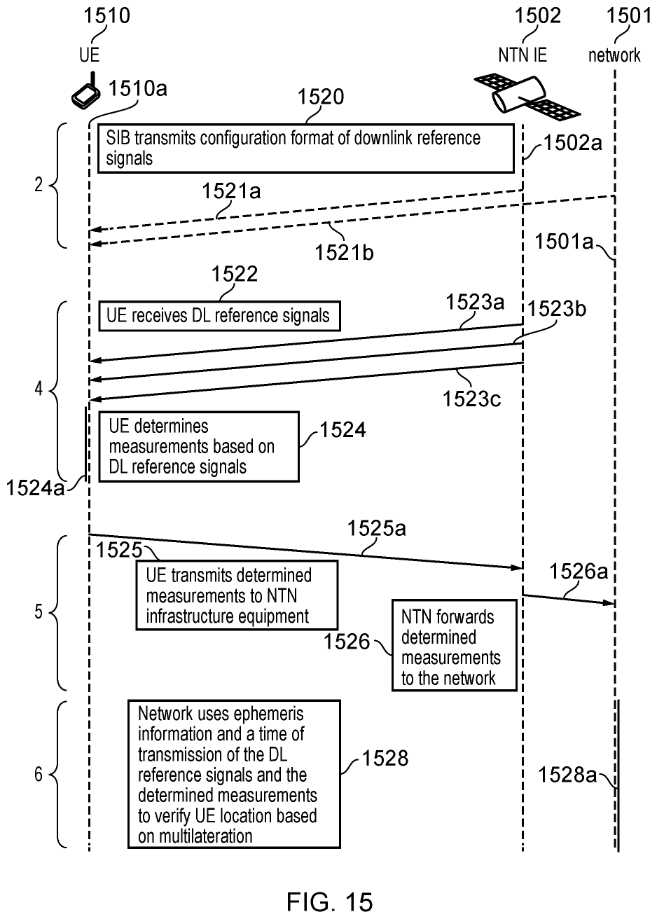

Having a set of {location, verification} information consisting of multiple individual reports, the network can attempt to confirm that the set of information is consistent. An example verification is shown in FIG. 14. This location verification can be compared to that performed in FIG. 10 for a stationary UE. FIG. 14 shows a UE that is moving at 500 kmph. The scenario is shown with the satellite at three points in time and location, A, B and C, where the UE is correspondingly at locations A′, B′ and C′. Due to the similarity between this Figure and FIG. 10 described earlier, differences between the two Figures will be highlighted.
A: Positions of the satellite and UE respectively at A and A′ of FIG. 14 are identical to positions of the UE 1410 and satellite 1401 at instance A of FIG. 10. A distance 1417 of the satellite 1401 from the UE 1410 is 619 km (A→A′), based on a satellite altitude of 600 km. A propagation time for this distance is 2.063 ms.
B: The satellite 1401 at B is in the same situation as in FIG. 10, having moved 151 km 1416 to position B, however the UE 1410 moving at 500 kmph has travelled 2.8 km 1426 in 20 seconds to location B′. Although the UE 1410 has moved, the distance 1415 from the UE 1410 to the satellite 1401 is still approximately 600 km, due to the trigonometry of the situation. A propagation time for this distance is thus 2.000 ms as in FIG. 10.
C: Positions C and C′ demonstrate a greatest difference between FIGS. 10 and 14. The UE 1410 has moved a further 2.8 km 1426 from location B′ to location C′. A distance 1417 from the UE 1410 to the satellite 1401 is now 617.3 km. A propagation time is 2.058 ms, reduced from the 2.063 ms seen in FIG. 10.

In this case, the UE would report a set of its location and verification measurements at points A′, B′ and C′. In order to verify the set of locations reported by the UE, the network would check for verification information that was consistent with propagation times of 2.063 ms, 2.000 ms and 2.058 ms at satellite locations A, B and C respectively.

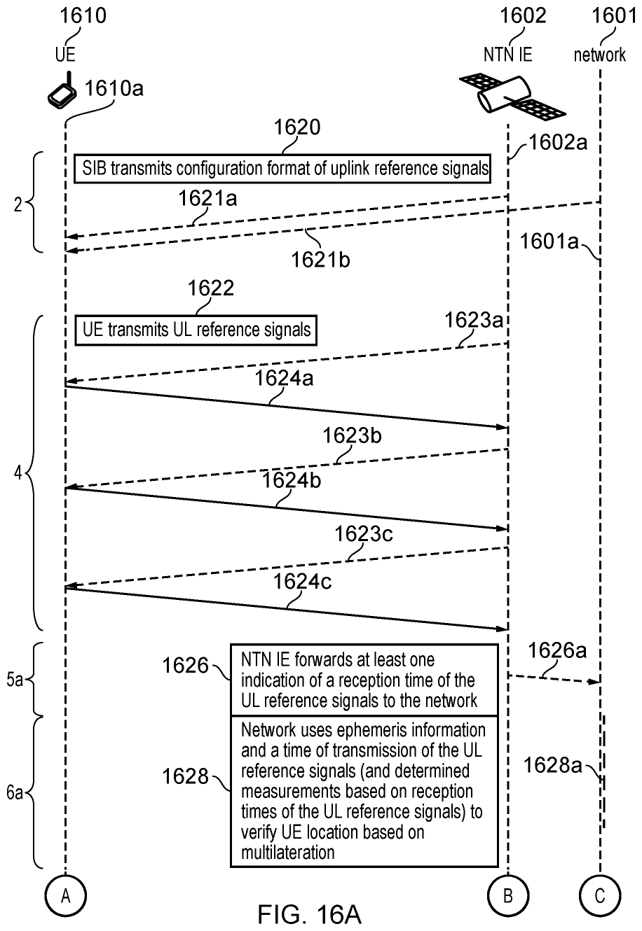

FIG. 15 depicts an example embodiment and is based on FIG. 12, and provides further clarification on the process by which the location of the UE may be determined or verified. FIG. 15 provides an example diagrammatic representation of the message flow between a UE 1510, a Non-terrestrial Network Infrastructure Equipment, NTN IE, 1502, and a network 1501. FIG. 15 includes process steps of FIG. 12 in more detail to help illustrate example embodiments. Step 2 on FIG. 12 is represented as step 2 in FIG. 15, with a further representation of a first stage, 1520, in which a system information block, SIB, carries a configuration format of downlink reference signals, which are to be received by the UE 1510. This corresponds to step 2 of FIG. 12, as indicated on the left of FIG. 15 by the step number 1505 being represented as “2”. Two dashed lines, 1521a and 1521b, represent a communication of the configuration format of the DL reference signals from either the NTN IE 1502 or the network 1501 (via the NTN IE 1502), indicating that in implementing the embodiment, it may be decided that one of the two presented options (communication from the NTN IE or the network) is to be preferred. Explicitly, the two example options presented herein relate to the SIB being transmitted from the NTN IE 1521a, or from another part of the network, 1521b.

In a second stage 4 of the message flow of FIG. 15, as indicated by the step number “4” on the left edge of FIG. 15, the UE 1510 receives the downlink reference signals 1523 for which the configuration format was transmitted to the UE 1510 in step 2. These reference signals include a plurality of signals, where in FIG. 15 there are, as an example, three reference signals represented by three arrows 1523a, 1523b, and 1523c (collectively referred to as references signals 1523) from the NTN IE to the UE 1510. As the skilled person would understand, the present disclosure is not so limited to three reference signals, and there may be more than three signals or less than three signals.

Still referring to a second stage 4 of the message flow, the UE 1510 uses the downlink reference signals 1523 to determine measurements 1524 related to the downlink reference signals 1523. This process of determining measurements is indicated by the vertical line 1524a beside the dashed line 1510a indicating the UE 1510.

Referring now to a third stage 5, the UE 1510 may transmit the determined measurements related to the downlink reference signals 1523 to the NTN IE 1502, which may then forward the determined measurements to the network. These are referred to by numerals 1525 and 1526 respectively, and represented by arrows 1525a and 1526a, and correspond to step 5 of the example process described in FIG. 12.

In a final stage 6, the network 1501, having received the determined measurements relating to the downlink reference signals 1523 received by the UE 1510, proceeds to use these, in combination with ephemeris information related to the NTN IE 1502, where for each of the reference signals 1523a, 1523b and 1523c, the ephemeris information related to the NTN IE at the time of transmission of each of those reference signals is considered, and a time of transmission for each of the downlink reference signals 1523 for which it has a determined measurement to which it relates, to verify the UE 1510 location. This is represented by the vertical line 1528a and process step 1528 in FIG. 15. As explained above, using the ephemeris information that was valid when each downlink reference signal was transmitted and a time when the downlink reference signals 1523 were transmitted, a location of the UE can be verified by multilateration using a difference in the inter-arrival times of the downlink reference signals 1523 from a location of the NTN IE when the measurements were determined.

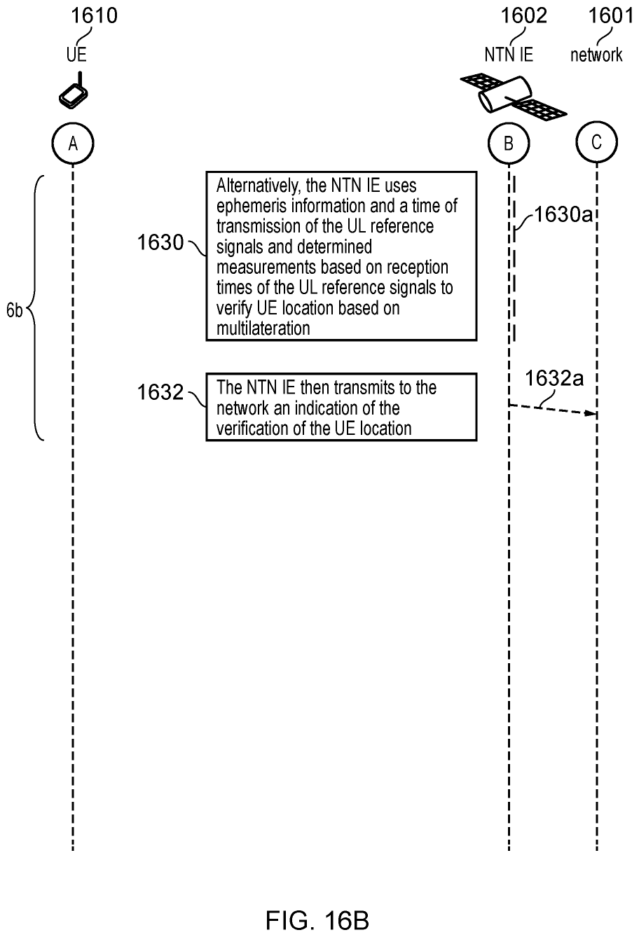

FIG. 16A and FIG. 16B depict an example embodiment of the present disclosure, and represent a flow diagram for an uplink example process of determining or verifying a location of a UE. FIGS. 16A and 16B represent a message flow between a UE 1610, a non-terrestrial infrastructure equipment, NTN IE 1602, and a network 1601 to which the NTN IE 1602 is connected (not shown).

Similar stages of the uplink example process are numbered corresponding to stages of FIG. 15. For example, a first stage is numbered “2” on the left of FIG. 16A to show a corresponding stage in FIG. 15, and a corresponding stage in FIG. 12. It should be understood that the process depicted in FIGS. 16A and 16B is directed toward an uplink process for determining or verifying a location of the UE, whereas FIGS. 12 and 15 address a downlink process for determining or verifying a location of the UE. Therefore, where stages in FIGS. 12, 15, 16A and 16B are denoted by the same number, this is to be understood as a corresponding stage in a respective process, not as the same stage in a respective process. For example, the stage numbered “4” in FIG. 16A contains the transmission of reference signals between the UE and the NTN IE, which corresponds to the transmission of reference signals between the UE and the NTN IE in stage 4 of FIG. 15, although the signals in FIG. 16A are uplink signals transmitted by the UE and the signals in FIG. 15 are downlink signals transmitted by the NTN IE.

A process depicted in FIG. 16A begins with a first stage, numbered “2” on the left of FIG. 16A. Within this stage, a system information block, SIB, carries a configuration format of uplink reference signals 1620, which is received by the UE 1610. This SIB may be transmitted either by the NTN IE 1602 to the UE 1610, or by the network 1601 to the UE 1610. This is depicted by dashed arrows 1621a and 1621b from the NTN IE 1602 and from the network 1601 respectively, both arrows terminating at the UE 1610.

In a second stage, numbered “4” on the left of FIG. 16A, the UE 1610 transmits uplink reference signals to the NTN IE 1602, as seen in 1622. These uplink reference signals are labelled 1624a, 1624b and 1624c respectively, and may be referred to collectively as uplink reference signals 1624. As would be appreciated by the skilled person, in FIG. 16A there are depicted three such uplink reference signals but the disclosure is not so limited. There may be more than three uplink reference signals transmitted by the UE 1610 to the NTN IE 1602 in some embodiments, or in other example embodiments there may be fewer than three such uplink reference signals.

Still referring to the second stage, a time at which the UE 1610 transmits the uplink reference signals 1624 may be determined by the SIB that it has received in the first stage. For instance, the UE 1610 may send uplink reference signals 1624 to the NTN IE 1602 on a frame boundary, or on a subframe boundary, or at another time known by the NTN IE 1602, e.g. three OFDM symbols after a frame boundary in an example where the frame contains OFDM symbols. Alternatively, the transmission of the uplink reference signals 1624 from the UE 1610 may be in response to a reception of reference signals from the NTN IE 1602. These reference signals are represented by dashed arrows 1623a, 1623b, and 1623c in FIG. 16A, and collectively referred to as reference signals 1623.

In a third stage of the process of determining or verifying the location of the UE 1610, the NTN IE 1602 may forward an indication of a time of reception of the uplink reference signals 1624 to the network, as denoted by 1626 in FIG. 16A, and illustrated with dashed arrow 1626a. A fourth stage, of processing, may then be carried out by the network 1601 as denoted by 1628 and vertical line 1628a in FIG. 16A. The network 1601 may use ephemeris information related to the NTN IE 1602, where for each of the reference signals 1624a, 1624b and 1624c, the ephemeris information related to the NTN IE at the time of reception of each of those reference signals is considered, and a time of reception for each of the uplink reference signals 1624, and a time of transmission for each of the reference signals 1623 to verify the UE 1610 location based on multilateration.

In other example embodiments, the NTN IE 1602 may be able to process the reception times of the uplink reference signals, and determine measurements based on the reception times of the uplink reference signals, such as an inter-arrival time of a plurality of uplink reference signals 1624, a Round Trip Time of signals transmitted to the UE 1610 from the NTN IE 1602 and transmitted back to the NTN IE 1602 from the UE 1610, or other appropriate measurements. In some example embodiments, the NTN IE 1602 may then send only these measurements to the network 1601, rather than an indication of the reception times of the uplink reference signals 1624. The network 1601 may then use these determined measurements to verify the UE 1610 location.

FIG. 16B continues from FIG. 16A and provides a further example for a final stage of processing the uplink reference signals to verify the location of the UE 1610. In some embodiments, the NTN IE 1602 may have sufficient processing capabilities to carry out processing of the reception times of the uplink reference signals 1624, as denoted by 1630 and illustrated by line 1630a. In this case, the NTN IE 1602 carries out the verification of the UE 1610 location, and then transmits to the network 1601 an indication of an outcome of the UE location verification. For instance, it may transmit to the network 1601 an indication that the UE 1610 has had its location verified successfully, or it may transmit to the network 1601 an indication that the UE 1610 has failed the location verification process. This is depicted by reference numeral 1632, and illustrated by dashed arrow 1632a. If the UE's location has been verified successfully then a communication service may be provided to the UE or communication service previously requested may be allowed to proceed.

### Other Measurements for UE Location Verification

Embodiments described so far have focused on location verification using timing measurements. The skilled person would appreciate that location verification can also be carried out with reference to other measurements and that these are not to be considered outside the scope of the present disclosure. For the avoidance of doubt, several further embodiments are provided below wherein the present disclosure is implemented without utilisation of timing measurements.

RSRP measurements can be used to provide an indication of pathloss between a UE and a satellite. Given a known transmission power, known relationships between pathloss and propagation distance can then be used to estimate a distance between the UE and satellite. A UE location can then be multilaterated based on these distances. However, this embodiment has to take into account atmospheric effects and other factors that disrupt the transmission of signals through an air interface e.g. cloud absorption.

A frequency offset of a signal from a UE depends on a location of the UE in a cell. For example, a UE that is directly below a satellite would have a low frequency offset due to Doppler shift while a UE that has a low angle of incidence (i.e. where the satellite is low on the horizon) would have a higher frequency offset. The frequency offset/Doppler shift would hence provide some information on UE location that could be used for verification. For example, in order to verify that the UE is located in the centre of a cell shown in FIG. 10, the satellite/network could test for high positive frequency offset, low frequency offset and high negative frequency offset as the satellite moves from A to C.

Alternatively, while UE location verification is concerned with verifying a location of a UE in an NTN system, that location could be verified by taking measurements of a terrestrial system before reporting to the NTN system. This scenario is particularly applicable when an operator of the NTN system has a commercial/service relationship with a Terrestrial Network, TN, operator. This embodiment is also suitable for verifying a location of Rel-17 UEs that would not have implemented any of the above described NTN RAT-dependent verification methods. The UE can take measurements of a terrestrial network and report these to the NTN system. For example, the UE can take measurements of the DL-TDOA of PRS from the terrestrial network and report these to the NTN system. The NTN system can then verify the location of the UE based on these measurements. This verification could possibly be aided by knowledge of locations of TN gNBs and/or by communication with the Location server (LCS).

### Security/Reliability of Verification Information

A UE could provide incorrect verification measurements in order to spoof a system into believing that the UE is in a location other than a location in which the UE is actually situated. Although the UE may attempt to spoof certain verification information, the present disclosure is still considered relevant for the purposes of UE location verification. While there is some level of engineering effort associated with sending an incorrect UE location, there is yet further engineering effort associated with spoofing verification information. Spoofing the verification information would require significant engineering effort to modify firmware within a device. For instance, physical layer measurements and transmit timing may need to be altered. Protocol layers within the device may also need to be altered and it may be found to be difficult to undertake engineering of this manner and scope. Furthermore, the firmware within the device may by cryptographically signed, making it extremely difficult or impossible to modify the UE's firmware with spoofed verification code.

### Further Technical Considerations

It will be appreciated that the present disclosure, which covers both LEO, MEO, and in some cases GEO, satellites relates to satellites of different heights, where heights of two different satellites may differ by a factor of more than 10, for example, a LEO satellite of 1200 km, and a MEO satellite of height 20,000 km. Therefore a propagation delay in communications between a ground-based UE and a satellite may also vary by a factor of more than ten.

Some embodiments, in which the NTN infrastructure equipment waits a period of 20 seconds after transmitting a first signal, for example, before transmitting a second signal, and another 20 seconds before transmitting a third signal may therefore not be appropriate for implementation in embodiments where satellites are used which possess a different orbital height when compared to the example orbital height of the satellite in the above embodiments, which was 600 km. Therefore, other thresholds and methods of determining when the transmissions should be sent have been devised.

In some embodiments, knowing a height of the satellite to which the UE is transmitting signals to, or from which the UE is receiving signals, the network may send to the UE and/or the satellite an indication of the threshold to be satisfied for subsequent transmissions to proceed. In one example embodiment, the network may determine that a delay between transmissions from the NTN satellite of 20 seconds is sufficient. Alternatively, other lengths of time may be determined and signalled to the UE and the satellite, for example 10 seconds, or 30 seconds or a different length of time.

In other example embodiments, a threshold for determining when transmissions should be sent is not dependent on time. In some example embodiments, the network may calculate when an angle of incidence of a signal at a receiving body (i.e. the UE in a downlink embodiment or the satellite in an uplink embodiment) has changed by a set amount. For example, the network may communicate to a transmitting body an indication of when it is to send a signal, based on a time to allow the angle of incidence of the signal when received at the receiving body to vary through an angle of 15 degrees, or some other angle pre-determined by the network.

In other example embodiments, a threshold for determining when transmissions should be sent is not dependent on time or an angle of incidence of the transmissions at a receiving body. For instance, the threshold may be that a satellite has travelled a certain distance. In this example embodiment, the threshold may be that a transmitting body may send a signal when the satellite has travelled a distance of 200 km from its previous position, or other suitable distance as pre-determined by the network.

In other example embodiments, a transmitting body may have increased processing power and/or be able to calculate a Time of Flight for a transmission between itself and a receiving body. In this embodiment, a threshold to be satisfied before transmission of a signal to the receiving body can be executed may be a difference in the Time of Flight, either by a certain amount, such as a variation by at least 0.05 ms, or by a proportion of the Time of Flight for the transmission such as a variation by at least 0.005%.

In other example embodiments, a threshold may be determined by anticipation of TDOA measurements. For example, the receiving body may utilise TDOA measurements to determine a location of a UE, and may require a difference of at least 0.05 ms in subsequent Time of Flight calculations in order to process resulting TDOA measurements, in which case the threshold may be determined by a transmitting body such that the difference between consecutive resulting TDOA measurements is not less than 0.05 ms.

Other suitable thresholds may be employed as appreciated by the skilled person. In particular, other considerations may be necessary when other techniques described above such as RSRP measurements, Doppler shift, or terrestrial measurements are used to verify a location of a UE. In these embodiments, suitable thresholds as determined by the skilled person and their technical understanding are to be implemented, in line with the principles and concepts disclosed above. The above disclosure is not intended to be limited to precisely what has been disclosed, for instance other threshold values may be used where the threshold value has not been disclosed as precisely and only one value. Thresholds may be implemented alone, so that there is only one threshold to be satisfied, or a plurality of thresholds may be implemented, in which case the transmission might be allowed only after satisfying every threshold, or the transmission might be allowed after satisfying only a subset of the implemented plurality of thresholds.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:

Paragraph 1. A method performed by a user equipment, UE, the method comprising
receiving, from a non-terrestrial network, NTN, infrastructure equipment forming part of a wireless communications network, a first signal, the first signal having been transmitted when the NTN infrastructure equipment is in a first orbital location,
determining a first measurement based on the received first signal,
receiving, from the NTN infrastructure equipment at a time later than a time of the reception of the first signal, at least one further signal, the at least one further signal being received when the NTN infrastructure equipment is in one or more different orbital locations, which are different from the first orbital location,
determining at least one further measurement based on the received at least one further signal, and
transmitting an indication for determining a relative difference between the determined first measurement and the determined at least one further measurement to the wireless communications network over a wireless access interface provided by the wireless communications network for the wireless communications network to determine or to verify a location of the UE based on the indication for determining the relative difference between the first and the at least one further measurements caused by the NTN infrastructure equipment being in the first and the one or more different orbital locations when the first signal and the at least one further signal were transmitted.

Paragraph 2. A method of paragraph 1, wherein the first measurement and the at least one further measurement are measurements of a time of arrival of the first signal with respect to that of a previous signal and the at least one further signal with respect to at least the first signal, the first signal, the previous signal and the at least one further signal being transmitted at known intervals by the NTN infrastructure equipment and the indication for determining a relative difference between the determined first measurement and the determined at least one further measurement is a downlink observed time difference of arrival measurement of a difference in the inter-arrival time measurements.

Paragraph 3. A method of any of paragraphs 1 or 2, wherein the transmitting the indication of the relative difference between the determined first measurement and the determined at least one further measurement to the wireless communications network comprises transmitting by the UE the indication of the relative difference to the wireless communications network via either Radio Resource Control, RRC, or Media Access Control, MAC, signalling.

Paragraph 4. A method of any of paragraphs 1, 2 or 3, wherein the transmitting the indication for determining the relative difference between the determined first measurement and the determined at least one further measurement to the wireless communications network comprises transmitting either at a time after the first signal and again at a time after the at least one further signal is received, or only transmitting at a time after a set of signals including the first and the one further signal is received by the UE.

Paragraph 5. A method of any of paragraphs 1 to 4, comprising receiving from the wireless communications network an indication that the location of the UE must be verified as part of an RRC Setup procedure.

Paragraph 6. A method of any of paragraphs 2 to 5, wherein the transmitting the indication for determining the relative difference between the determined first measurement and the determined at least one further measurement to the wireless communications network comprises transmitting the inter-arrival time measurements, at least one time difference between the inter-arrival time measurements, and/or a Time of Flight of communication between the NTN infrastructure equipment and the UE.

Paragraph 7. A method of any of paragraphs 1 to 6, comprising
determining, by the UE, a location of the UE using a Global Navigation Satellite Systems, GNSS, from signals received by the UE from GNSS satellites or a Terrestrial Beacon System, TBS, from signals received by the UE from TBS transmitter, and
transmitting, from the UE to the wireless communications network, the determined location of the UE with the indication for determining a relative difference between the determined first measurement and the determined at least one further measurement.

Paragraph 8. A method performed by a user equipment, UE, the method comprising:
transmitting, to a non-terrestrial network, NTN, infrastructure equipment forming part of a wireless communications network, a first reference signal via a wireless access interface of the wireless communications network formed by the NTN infrastructure equipment, the first reference signal being transmitted at a time determined from a reference forming part of the wireless access interface and the first reference signal is transmitted when the NTN infrastructure equipment is in a first orbital location,
transmitting, to the NTN infrastructure equipment at a time later than a time of the transmission of the first reference signal, at least one further reference signal via the wireless access interface, the at least one further reference signal being transmitted at a time determined from a reference forming part of the wireless access interface, the at least one further signal being transmitted when the NTN infrastructure equipment is in one or more different orbital locations, which are different from the first orbital location, a difference in an arrival time of the first reference signal and the at least one further reference signal with respect to the reference of the wireless access interface for determining or verifying by the wireless communications network a location of the UE based on measurements determined by the NTN infrastructure equipment, the difference in an arrival time being caused by the NTN infrastructure equipment being in the first and the one or more different orbital locations when the first reference signal and the at least one further reference signal were transmitted.

Paragraph 9. A method of paragraph 8, comprising
receiving from the wireless communications network an indication that the location of the UE must be verified as part of an RRC Setup procedure.

Paragraph 10. A method of paragraph 8 or 9, comprising
determining, by the UE, a location of the UE using a Global Navigation Satellite Systems, GNSS, from signals received by the UE from GNSS satellites or a Terrestrial Beacon System, TBS, from signals received by the UE from TBS transmitter, and
transmitting, from the UE to the wireless communications network, the determined location of the UE.

Paragraph 11. A method of paragraph 8, 9 or 10, comprising
receiving a timing advance from the wireless communications network for the UE to apply when transmitting to the NTN infrastructure equipment, and the transmitting, to the NTN infrastructure equipment, the first reference signal and the at least one further reference signal via the wireless access interface with respect to the reference forming part of the wireless access interface comprises
transmitting, to the NTN infrastructure equipment, the first reference signal and the at least one further reference signal comprises adjusting the times of transmission with respect to the reference in the wireless access interface to include the timing advance.

Paragraph 12. A method of paragraph 11, wherein the UE performs one or more of: applying a timing advance to the first reference signal and the at least one further reference signal transmitted between the UE and the NTN infrastructure equipment, applying a timing advance when transmitting the first reference signal and the at least one further reference signal that is signalled to the UE by the wireless communications network, or determining a timing advance, applying the determined timing advance when transmitting the first reference signal and the at least one further reference signal, and signalling to the wireless communications network an indication of the timing advance that the UE applied.

Paragraph 13. A method of determining or verifying a location of a user equipment, UE, the method comprising:
receiving, at a non-terrestrial network, NTN, infrastructure equipment from the UE, a first reference signal transmitted via a wireless access interface of the wireless communications network formed by the NTN infrastructure equipment, the first signal being received when the NTN infrastructure equipment is in a first orbital location,
determining a first measurement from the first reference signal, the first reference signal having been transmitted at a time determined from a reference forming part of the wireless access interface,
receiving, at a NTN infrastructure equipment from the UE, at a time later than a time of reception of the first reference signal, at least one further reference signal transmitted via the wireless access interface, the at least one further reference signal being received when the NTN infrastructure equipment is in one or more different orbital locations, which are different from the first orbital location,
determining at least one further measurement from the at least one further reference signal, the at least one further reference signal having been transmitted at a time with respect to a reference forming part of the wireless access interface, and either
determining a difference in a propagation time between the first reference signal and the at least one further reference signal from the first measurement and the at least one further measurement, and determining by the NTN infrastructure equipment a location of the UE or verifying a location of the UE based on the determined difference in the propagation times of the first reference signal and the at least one further reference signal, or
reporting the first measurement and the at least one further measurement to the wireless communications network for the wireless communications network to determine a location of the UE or verify a location of the UE based on a difference in propagation times of the first reference signal and the at least one further reference signal caused by the NTN infrastructure equipment being in the first and the one or more different orbital locations when the first signal and the at least one further signal were transmitted

Paragraph 14. A method of paragraph 13, wherein the determining the location of the UE or verifying the location includes
determining by the NTN infrastructure equipment the location of the UE or verifying the location of the UE based on the determined difference in the propagation times of the UE.

Paragraph 15. A method of paragraph 14, wherein the determining the location of the UE or verifying the location includes
reporting the location of the user equipment to the wireless communications network over the wireless access interface.

Paragraph 16. A method of paragraph 15, comprising comparing the location of the user equipment with a reported location of the user equipment, and reporting to the wireless communications network a result of the comparison.

Paragraph 17. A method of paragraph 15, wherein the difference in the propagation time between the first reference signal and the at least one further reference signal is an uplink time difference of arrival.

Paragraph 18. A method of paragraph 13, wherein the reporting the first measurement and the at least one further measurement to the wireless communications network comprises
transmitting by the NTN infrastructure equipment the determined first measurement and the at least one further measurements to the wireless communications network.

Paragraph 19. A method of paragraph 14, wherein the reporting the first measurement and the at least one further measurement to the wireless communications network by the NTN infrastructure equipment comprises reporting the first measurement and the at least one further measurement to the wireless communications network after the first and the at least one further reference signal is received, or only after a set of reference signals are received by the NTN infrastructure equipment.

Paragraph 20. A method of paragraph 13, wherein the reporting the first measurement and the at least one further measurement to the wireless communications network by the NTN infrastructure equipment comprises transmitting the first measurement and the at least one further measurement in a form that is one of: at least one inter-arrival time of the signals at the NTN infrastructure equipment, at least one difference of inter-arrival times of the signals at the NTN infrastructure equipment, at least one Round Trip Time of communication between the NTN infrastructure equipment and the UE, and at least one Time of Flight of communication between the NTN infrastructure equipment and the UE.

Paragraph 21. A method of paragraph 13, wherein the first reference signal and the at least one further reference signal are received by the NTN infrastructure equipment after a timing advance has been applied to them by the UE.

Paragraph 22. A method of paragraph 1, wherein the first measurement based on the received first signal, and the at least one further measurement based on the at least one further signal is one of: a reference signal received power, a Doppler shift, and/or a measurement of terrestrial network signals.

Paragraph 23. A method according to any of paragraphs 1 to 22, wherein the NTN infrastructure equipment is located on a Low Earth Orbit, LEO, or Medium Earth Orbit, MEO, satellite.

Paragraph 24. A method according to any of paragraphs 1 to 12, comprising
receiving, from the wireless communications network an indication of ephemeris information associated with the at least one NTN infrastructure equipment, and
determining, on the basis of the indication of the ephemeris information, a location of the NTN infrastructure equipment.

Paragraph 25. A communications device comprising
transceiver circuitry configured to transmit signals to a wireless communications network via a wireless access interface provided by the wireless communications network, the wireless communications network including a non-terrestrial network, NTN, infrastructure equipment, and to receive signals from the wireless communications network via the wireless access interface, and
controller circuitry configured to control the transceiver circuitry
to receive a first signal transmitted via the wireless access interface from the NTN infrastructure equipment, the first signal having been transmitted when the NTN infrastructure equipment is in a first orbital location,
to determine a first measurement based on the received first signal,
to receive at a time later than a time of the reception of the first signal, at least one further signal from the NTN infrastructure equipment transmitted via the wireless access interface, the at least one further signal being received when the NTN infrastructure equipment is in one or more different orbital locations, which are different from the first orbital location,
to determine at least one further measurement based on the received at least one further signal, and
to transmit an indication for determining a relative difference between the determined first measurement and the determined at least one further measurement to the wireless communications network over a wireless access interface provided by the wireless communications network for the wireless communications network to determine or to verify a location of the UE based on the indication for determining the relative difference between the first and the at least one further measurements caused by the NTN infrastructure equipment being in the first and the one or more different orbital locations when the first signal and the at least one further signal were transmitted.

Paragraph 26. A communications device of paragraph 25, wherein the first measurement and the at least one further measurement are measurements of a time of arrival of the first signal with respect to that of a previous signal and the at least one further signal with respect to at least the first signal, the first signal, the previous signal and the at least one further signal being transmitted at known intervals by the NTN infrastructure equipment and the indication for determining a relative difference between the determined first measurement and the determined at least one further measurement is a downlink observed time difference of arrival measurement of a difference in the inter-arrival time measurements.

Paragraph 27. A non-terrestrial network, NTN, infrastructure equipment forming part of a wireless communications network, the infrastructure equipment comprising
transceiver circuitry configured to receive signals from one or more communications devices transmitted via a wireless access interface provided by the wireless communications network, the wireless communications network including the NTN infrastructure equipment, and to transmit signals to one or more communications devices transmitted via the wireless access interface, and
controller circuitry configured to control the transceiver circuitry
to transmit, to a communications device from the NTN infrastructure equipment forming part of the wireless communications network, a first signal and at a time later than a time of the transmission of the first signal, at least one further signal via the wireless access interface, the first signal and the at least one further signal being transmitted when the NTN infrastructure equipment is in different orbital locations,
to receive, from the communication device, an indication for determining a relative difference between a first measurement based on the received first signal and at least one further measurement based on the received at least one further signal for determining or for verifying a location of the UE based on the indication for determining the relative difference between the first and the at least one further measurements caused by the NTN infrastructure equipment being in the first and the one or more different orbital locations when the first signal and the at least one further signal were transmitted.

Paragraph 28. An NTN infrastructure equipment of paragraph 27, wherein the first measurement and the at least one further measurement are measurements of a time of arrival of the first signal with respect to that of a previous signal and the at least one further signal with respect to at least the first signal, the first signal, the previous signal and the at least one further signal being transmitted at known intervals by the NTN infrastructure equipment and the indication for determining a relative difference between the determined first measurement and the determined at least one further measurement is a downlink observed time difference of arrival measurement of a difference in the inter-arrival time measurements.

Paragraph 29. A communications device comprising
transceiver circuitry configured to transmit signals to a wireless communications network via a wireless access interface provided by the wireless communications network, the wireless communications network including a non-terrestrial network, NTN, infrastructure equipment, and to receive signals from the wireless communications network via the wireless access interface, and
controller circuitry configured to control the transceiver circuitry
to transmit, to the NTN infrastructure equipment forming part of the wireless communications network, a first reference signal via the wireless access interface, the first reference signal being transmitted at a time determined from a reference forming part of the wireless access interface and the first reference signal is transmitted when the NTN infrastructure equipment is in a first orbital location, to transmit, to the NTN infrastructure equipment at a time later than a time of the transmission of the first reference signal, at least one further reference signal via the wireless access interface, the at least one further reference signal being transmitted at a time determined from a reference forming part of the wireless access interface, the at least one further signal being transmitted when the NTN infrastructure equipment is in one or more different orbital locations, which are different from the first orbital location, a difference in an arrival time of the first reference signal and the at least one further reference signal with respect to the reference of the wireless access interface for determining or verifying by the wireless communications network a location of the UE based on measurements determined by the NTN infrastructure equipment, the difference in an arrival time being caused by the NTN infrastructure equipment being in the first and the one or more different orbital locations when the first reference signal and the at least one further reference signal were transmitted.

Paragraph 30. A non-terrestrial network, NTN, infrastructure equipment forming part of a wireless communications network for determining or verifying a location of a communications device, the infrastructure equipment comprising
transceiver circuitry configured to receive signals from one or more communications devices transmitted via a wireless access interface provided by the wireless communications network, the wireless communications network including the NTN infrastructure equipment, and to transmit signals from one or more communications devices transmitted via the wireless access interface, and
controller circuitry configured to control the transceiver circuitry
to receive, from a communications device, a first reference signal transmitted via the wireless access interface, the first signal being received when the NTN infrastructure equipment is in a first orbital location,
to determine a first measurement from the first reference signal, the first reference signal having been transmitted at a time determined from a reference forming part of the wireless access interface,
to receive, from the UE, at a time later than a time of reception of the first reference signal, at least one further reference signal transmitted via the wireless access interface, the at least one further reference signal being received when the NTN infrastructure equipment is in one or more different orbital locations, which are different from the first orbital location,
to determine at least one further measurement from the at least one further reference signal, the at least one further reference signal having been transmitted at a time with respect to a reference forming part of the wireless access interface, and either
to determine a difference in a propagation time between the first reference signal and the at least one further reference signal from the first measurement and the at least one further measurement, and to determine by the NTN infrastructure equipment a location of the communications device or to verify a location of the UE based on the determined difference in the propagation times of the first reference signal and the at least one further reference signal caused by the NTN infrastructure equipment being in the first and the one or more different orbital locations when the first signal and the at least one further signal were transmitted, or
to report the first measurement and the at least one further measurement to the wireless communications network for the wireless communications network to determine a location of the communications device or verify a location of the communications device based on a difference in propagation times of the first reference signal and the at least one further reference signal caused by the NTN infrastructure equipment being in the first and the one or more different orbital locations when the first signal and the at least one further signal were transmitted.

Paragraph 31. An apparatus forming part of a wireless communications network for determining or verifying a location of a communications device, the apparatus including processor circuitry configured to execute program code, which when executed causes the processor circuitry to perform the operations of
receiving a first measurement and at least one further measurement, the first measurement being a time difference between when a first signal was received by a non-terrestrial network, NTN, infrastructure equipment from the communications device with respect to a reference forming part of the wireless access interface, and the at least one further measurement being a time difference when at least one further signal was received by the NTN infrastructure equipment from the communications device with respect to a reference forming part of the wireless access interface, the first signal and the at least one further signal being transmitted when the NTN infrastructure equipment is in different orbital locations, and
determining or verifying a location of the communications device based on the determined difference in the propagation times of the first reference signal and the at least one further reference signal caused by the NTN infrastructure equipment being in the first and the one or more different orbital locations when the first signal and the at least one further signal were transmitted.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] RP-220953. “NR NTN (Non-Terrestrial Networks) enhancements”. RAN plenary #95e. March 2022.
[2] RP-221013. <<95e-25 email discussion
[3] RP-220139: Network verified UE location aspects; THALES
[4] RP-220174: Network verification of UE location in NTN; Qualcomm Incorporated 79
[5] RP-220200: On Network-verified UE location for NR NTN; Intel Corporation
[6] RP-220421: Discussion on network-verified UE location for NR NTN; Huawei, HiSilicon
[7] R2-2101150 Summary of [Post112-e][115] [NTN] the Email Discussion on LCS for NTN, Fraunhofer IIS, Fraunhofer HHI
[8] S3i210282
[9] R2-2102679, Reply LS on UE location aspects in NTN.
[10] R2-1913493 UE positioning in legacy satellite communication systems for 5G NTN THALES
[11] 3GPP TS 38.305 V16.0.0 (2020-03): 3rd Generation Partnership Project; Technical Specification Group Radio Access Network; NG Radio Access Network (NG-RAN); Stage 2 functional specification of User Equipment (UE) positioning in NG-RAN (Release 16)
[12] 3GPP TR38.821. “Solutions for NR to support non-terrestrial networks (NTN)”
[13] TR 38.470.
[14] 3GPP TR 22.926 Guidelines for Extraterritorial 5G Systems; Stage 1 (Release 18)

1. A method performed by a user equipment, UE, the method comprising
receiving, from a non-terrestrial network, NTN, infrastructure equipment forming part of a wireless communications network, a first signal, the first signal having been transmitted when the NTN infrastructure equipment is in a first orbital location,
determining a first measurement based on the received first signal,
receiving, from the NTN infrastructure equipment at a time later than a time of the reception of the first signal, at least one further signal, the at least one further signal being received when the NTN infrastructure equipment is in one or more different orbital locations, which are different from the first orbital location,
determining at least one further measurement based on the received at least one further signal, and
transmitting an indication for determining a relative difference between the determined first measurement and the determined at least one further measurement to the wireless communications network over a wireless access interface provided by the wireless communications network for the wireless communications network to determine or to verify a location of the UE based on the indication for determining the relative difference between the first and the at least one further measurements caused by the NTN infrastructure equipment being in the first and the one or more different orbital locations when the first signal and the at least one further signal were transmitted.

2. A method of claim 1, wherein the first measurement and the at least one further measurement are measurements of a time of arrival of the first signal with respect to that of a previous signal and the at least one further signal with respect to at least the first signal, the first signal, the previous signal and the at least one further signal being transmitted at known intervals by the NTN infrastructure equipment and the indication for determining a relative difference between the determined first measurement and the determined at least one further measurement is a downlink observed time difference of arrival measurement of a difference in the inter-arrival time measurements.

3. A method of claim 1, wherein the transmitting the indication of the relative difference between the determined first measurement and the determined at least one further measurement to the wireless communications network comprises transmitting by the UE the indication of the relative difference to the wireless communications network via either Radio Resource Control, RRC, or Media Access Control, MAC, signalling.

4. A method of claim 1, wherein the transmitting the indication for determining the relative difference between the determined first measurement and the determined at least one further measurement to the wireless communications network comprises transmitting either at a time after the first signal and again at a time after the at least one further signal is received, or only transmitting at a time after a set of signals including the first and the one further signal is received by the UE.

5. A method of claim 1, comprising receiving from the wireless communications network an indication that the location of the UE must be verified as part of an RRC Setup procedure.

6. A method of claim 2, wherein the transmitting the indication for determining the relative difference between the determined first measurement and the determined at least one further measurement to the wireless communications network comprises transmitting the inter-arrival time measurements, at least one time difference between the inter-arrival time measurements, and/or a Time of Flight of communication between the NTN infrastructure equipment and the UE.

7. A method of claim 1, comprising
determining, by the UE, a location of the UE using a Global Navigation Satellite Systems, GNSS, from signals received by the UE from GNSS satellites or a Terrestrial Beacon System, TBS, from signals received by the UE from TBS transmitter, and
transmitting, from the UE to the wireless communications network, the determined location of the UE with the indication for determining a relative difference between the determined first measurement and the determined at least one further measurement.

8. A method performed by a user equipment, UE, the method comprising:
transmitting, to a non-terrestrial network, NTN, infrastructure equipment forming part of a wireless communications network, a first reference signal via a wireless access interface of the wireless communications network formed by the NTN infrastructure equipment, the first reference signal being transmitted at a time determined from a reference forming part of the wireless access interface and the first reference signal is transmitted when the NTN infrastructure equipment is in a first orbital location,
transmitting, to the NTN infrastructure equipment at a time later than a time of the transmission of the first reference signal, at least one further reference signal via the wireless access interface, the at least one further reference signal being transmitted at a time determined from a reference forming part of the wireless access interface, the at least one further signal being transmitted when the NTN infrastructure equipment is in one or more different orbital locations, which are different from the first orbital location, a difference in an arrival time of the first reference signal and the at least one further reference signal with respect to the reference of the wireless access interface for determining or verifying by the wireless communications network a location of the UE based on measurements determined by the NTN infrastructure equipment, the difference in an arrival time being caused by the NTN infrastructure equipment being in the first and the one or more different orbital locations when the first reference signal and the at least one further reference signal were transmitted.

9. A method of claim 8, comprising
receiving from the wireless communications network an indication that the location of the UE must be verified as part of an RRC Setup procedure.

10. A method of claim 8, comprising
determining, by the UE, a location of the UE using a Global Navigation Satellite Systems, GNSS, from signals received by the UE from GNSS satellites or a Terrestrial Beacon System, TBS, from signals received by the UE from TBS transmitter, and
transmitting, from the UE to the wireless communications network, the determined location of the UE.

11. A method of claim 8, comprising
receiving a timing advance from the wireless communications network for the UE to apply when transmitting to the NTN infrastructure equipment, and the transmitting, to the NTN infrastructure equipment, the first reference signal and the at least one further reference signal via the wireless access interface with respect to the reference forming part of the wireless access interface comprises
transmitting, to the NTN infrastructure equipment, the first reference signal and the at least one further reference signal comprises adjusting the times of transmission with respect to the reference in the wireless access interface to include the timing advance.

12. A method of claim 11, wherein the UE performs one or more of: applying a timing advance to the first reference signal and the at least one further reference signal transmitted between the UE and the NTN infrastructure equipment, applying a timing advance when transmitting the first reference signal and the at least one further reference signal that is signalled to the UE by the wireless communications network, or determining a timing advance, applying the determined timing advance when transmitting the first reference signal and the at least one further reference signal, and signalling to the wireless communications network an indication of the timing advance that the UE applied.

13. A method of determining or verifying a location of a user equipment, UE, the method comprising:
receiving, at a non-terrestrial network, NTN, infrastructure equipment from the UE, a first reference signal transmitted via a wireless access interface of the wireless communications network formed by the NTN infrastructure equipment, the first signal being received when the NTN infrastructure equipment is in a first orbital location,
determining a first measurement from the first reference signal, the first reference signal having been transmitted at a time determined from a reference forming part of the wireless access interface,
receiving, at an NTN infrastructure equipment from the UE, at a time later than a time of reception of the first reference signal, at least one further reference signal transmitted via the wireless access interface, the at least one further reference signal being received when the NTN infrastructure equipment is in one or more different orbital locations, which are different from the first orbital location,
determining at least one further measurement from the at least one further reference signal, the at least one further reference signal having been transmitted at a time with respect to a reference forming part of the wireless access interface, and either
determining a difference in a propagation time between the first reference signal and the at least one further reference signal from the first measurement and the at least one further measurement, and determining by the NTN infrastructure equipment a location of the UE or verifying a location of the UE based on the determined difference in the propagation times of the first reference signal and the at least one further reference signal, or
reporting the first measurement and the at least one further measurement to the wireless communications network for the wireless communications network to determine a location of the UE or verify a location of the UE based on a difference in propagation times of the first reference signal and the at least one further reference signal caused by the NTN infrastructure equipment being in the first and the one or more different orbital locations when the first signal and the at least one further signal were transmitted.

14. A method of claim 13, wherein the determining the location of the UE or verifying the location includes
determining by the NTN infrastructure equipment the location of the UE or verifying the location of the UE based on the determined difference in the propagation times of the UE.

15. A method of claim 14, wherein the determining the location of the UE or verifying the location includes
reporting the location of the user equipment to the wireless communications network over the wireless access interface.

16. A method of claim 15, comprising comparing the location of the user equipment with a reported location of the user equipment, and reporting to the wireless communications network a result of the comparison.

17. A method of claim 15, wherein the difference in the propagation time between the first reference signal and the at least one further reference signal is an uplink time difference of arrival.

18. A method of claim 13, wherein the reporting the first measurement and the at least one further measurement to the wireless communications network comprises transmitting by the NTN infrastructure equipment the determined first measurement and the at least one further measurements to the wireless communications network.

19. (canceled)

20. A method of claim 13, wherein the reporting the first measurement and the at least one further measurement to the wireless communications network by the NTN infrastructure equipment comprises transmitting the first measurement and the at least one further measurement in a form that is one of: at least one inter-arrival time of the signals at the NTN infrastructure equipment, at least one difference of inter-arrival times of the signals at the NTN infrastructure equipment, at least one Round Trip Time of communication between the NTN infrastructure equipment and the UE, and at least one Time of Flight of communication between the NTN infrastructure equipment and the UE.

21. A method of claim 13, wherein the first reference signal and the at least one further reference signal are received by the NTN infrastructure equipment after a timing advance has been applied to them by the UE.

22.-32. (canceled)
